(19) United States
(12) Patent Application Publication
(10) Pub. No.: US 2023/0172790 A1
(43) Pub. Date: Jun. 8, 2023

(54) GAS-TYPE MASSAGE DEVICE AND GAS-TYPE MASSAGE APPARATUS

(71) Applicant: TECHNO TAKATSUKI CO., LTD., Osaka (JP)

(72) Inventor: Kazuma SHIMIZU, Osaka (JP)

(21) Appl. No.: 18/060,798

(22) Filed: Dec. 1, 2022

(30) Foreign Application Priority Data
Dec. 2, 2021 (JP) 2021-196444

(51) Int. Cl. A61H 9/00

(52) U.S. Cl. CPC A61H 9/0092

(57) ABSTRACT

A gas-type massage device is a gas-type massage device to be fitted to at least one part of upper limbs or lower limbs of the human body along an axial direction in which the one part extends so as to surround the one part in a peripheral direction to administer a massage to the human body using a high-pressure gas, wherein the gas-type massage device has a plurality of gas chambers, each of which plurality of gas chambers expands and contracts mutually independently so as to receive a high-pressure gas to expand and discharge a high-pressure gas to contract, the plurality of gas chambers comprise first and second gas chamber groups to be provided so as to be mutually adjacent in the axial direction, and each of the first and second gas chamber group has at least two gas chambers along a peripheral direction.

### CROSS REFERENCE TO RELATED APPLICATION

This application claims priority to Japanese Patent Application No. 2021-196444 filed Dec. 2, 2021, which is hereby incorporated by reference in its entirety.

### TECHNICAL FIELD

The invention relates to a gas-type massage device and a gas-type massage apparatus.

### BACKGROUND OF THE INVENTION

A gas-type massage device to be fitted to upper limbs or lower limbs of a human body so as to surround the upper limbs or the lower limbs of the human body to administer a massage to the fitted part of the human body using a high-pressure gas is known.

For example, JP2005-073997A discloses a sleeve-shaped massage device to surround arms or legs of a human body. This massage device has a plurality of air chambers so as to be juxtaposed to the arms or the legs along the axial direction. Each of the air chambers is configured to be independently expandable and contractible by supplying and discharging of a compressed air. Therefore, the massage device of JP2005-073997A makes it possible to administer a massage to the human body by supplying a compressed air in order from an air chamber to be positioned at a position corresponding to the end of the upper limbs or the lower limbs of the human body, for example. It is believed that this causes the flow to the trunk of human body fluid such as lymph fluid to be promoted, making it possible to prevent building up of human body fluid in the upper limbs or the lower limbs.

### SUMMARY OF THE INVENTION

In the upper limbs or the lower limbs of the human body are present in the peripheral direction the vessel groups such as the independent lymph vessel groups in a plurality. The certain vessel group being damaged makes it difficult to pass body fluid such as lymph fluid via the above-mentioned vessel group. Therefore, it is believed that, in treating a disease such as lymphedema, in which lymphedema the vessel group does not function normally, so that body fluid builds up in the upper limbs or the lower limbs, passing body fluid group via the vessel group with no (or little) damage makes it possible to further prevent building up of body fluid. However, with the massage device of JP2005-073997A, the air chambers uniformly expand in the surrounding of the upper limbs or the lower limbs, equally applying pressure on the upper limbs or the lower limbs in the peripheral direction regardless of the presence/absence of damage in the vessel group. In this case, it is difficult for body fluid to flow to the trunk from the vessel group, in which vessel group body fluid easily builds up, so that building up of body fluid cannot be prevented much. Therefore, it is difficult to obtain a desired massaging effect with the massage device of JP2005-073997A.

In view of the above-described problems, an object of the invention is to provide a gas-type massage device and a gas-type massage apparatus that facilitate passing of body fluid toward its trunk.

A gas-type massage device according to one embodiment of the invention is a gas-type massage device to be fitted to at least one part of upper limbs or lower limbs of a human body along an axial direction in which the one part extends so as to surround the one part in a peripheral direction to administer a massage to the human body using a high-pressure gas, wherein the gas-type massage device has a plurality of gas chambers, each of which plurality of gas chambers can receive and discharge a high-pressure gas to expand and contract mutually independently, the plurality of gas chambers comprise a first gas chamber group and a second gas chamber group being provided so as to be mutually adjacent in the axial direction, and each of the first gas chamber group and the second gas chamber group has at least two gas chambers along the peripheral direction.

A gas-type massage apparatus according to one embodiment of the invention can be a gas-type massage apparatus to administer a massage to a human body using a high-pressure gas, wherein the gas-type massage apparatus comprises: the above-described gas-type massage device; and a gas supply/discharge system to supply a high-pressure gas to the plurality of gas chambers of the gas-type massage device and discharge a high-pressure gas from the plurality of gas chambers, and wherein the gas supply/discharge system is configured to supply a high-pressure gas to the first gas chamber group and then supply a high-pressure gas to the second gas chamber group.

A gas-type massage device and a gas-type massage apparatus according to one embodiment of the invention facilitate passing of human body fluid toward the trunk.

### BRIEF DESCRIPTION OF THE DRAWINGS

FIG. 1 is a schematic perspective view showing a gas-type massage apparatus according to a first embodiment.

FIG. 2 is a schematic perspective view showing the gas-type massage apparatus according to a variation of the first embodiment.

FIG. 3A is a schematic perspective view when viewed from the front, showing the first gas-type massage device.

FIG. 3B is a schematic perspective view when viewed from the rear, showing the first gas-type massage device.

FIG. 4 is a cross-sectional view along a line IV-IV line in FIG. 3A.

FIG. 5A is a schematic perspective view when viewed from the front, showing a second gas-type massage device.

FIG. 5B is a schematic perspective view when viewed from the rear, showing the second gas-type massage device.

FIG. 6 is a cross-sectional view along a line VI-VI line in FIG. 5A.

FIG. 7 is a schematic block diagram of a gas supply/discharge system.

FIG. 8A is a schematic view when viewed from the right front, showing a position of lymph vessel groups in the lower thigh of the human body.

FIG. 8B is a schematic view when viewed from the left side, showing a position of the lymph vessel groups in the lower thigh of the human body.

FIG. 8C is a schematic view when viewed from the rear, showing a position of the lymph vessel groups in the lower thigh of the human body.

FIG. 9(a) is a schematic view when the first gas-type massage device is fitted to the right leg and (b) is an explanatory diagram showing one example (Specific Example 1) of massaging steps at that time in the gas-type massage apparatus according to the first embodiment.

FIG. 10(a) to (d) are schematic views showing main steps of the massaging steps in FIG. 9(b).

FIG. 11(a) to (d) are schematic views showing main steps of the massaging steps in FIG. 9(b).

FIG. 12(a) to (c) are schematic views showing main steps of the massaging steps in FIG. 9(b).

FIG. 13 is an explanatory diagram showing one example (Specific Example 2) of massaging steps when the first gas-type massage device is fitted to the right leg in the gas-type massage apparatus according to the first embodiment.

FIG. 14 is an explanatory diagram showing one example (Specific Example 3) of massaging steps when the first gas-type massage device is fitted to the right leg in the gas-type massage apparatus according to the first embodiment.

FIG. 15(a) is a schematic view when the first gas-type massage device is fitted to the left leg and (b) is an explanatory diagram showing one example (Specific Example 4) of massaging steps at that time in the gas-type massage apparatus according to the first embodiment.

FIG. 16 is an explanatory diagram showing one example (Specific Example 5) of massaging steps when the first gas-type massage device is fitted to the left leg in the gas-type massage apparatus according to the first embodiment.

FIG. 17 is an explanatory diagram showing one example (Specific Example 6) of massaging steps when the first gas-type massage device is fitted to the left leg in the gas-type massage apparatus according to the first embodiment.

FIG. 18(a) is a schematic view when the gas-type massage device is fitted and (b) is an explanatory diagram showing one example (Specific Example 7) of massaging steps at that time in the gas-type massage apparatus according to a variation of the first embodiment.

FIG. 19 is an explanatory diagram showing one example (Specific Example 8) of massaging steps when the gas-type massage device is fitted in the gas-type massage apparatus according to the variation of the first embodiment.

FIG. 20 is an explanatory diagram showing one example (Specific Example 9) of massaging steps when the gas-type massage device is fitted in the gas-type massage apparatus according to the variation of the first embodiment.

FIG. 21 is a schematic front view showing the gas-type massage apparatus according to a second embodiment.

FIG. 22A is a cross-sectional view along a line XXIIA-XXIIA in FIG. 21.

FIG. 22B is a cross-sectional view along a line XXIIB-XXIIB in FIG. 21.

FIG. 23(a) is a schematic view when the gas-type massage device is fitted to the right arm and (b) is an explanatory diagram showing one example (Specific Example 10) of massaging steps at that time in the gas-type massage apparatus according to the second embodiment.

FIG. 24(a) to (d) are schematic views showing main steps of the massaging steps in FIG. 23(b).

FIG. 25(a) to (b) are schematic views showing main steps of the massaging steps in FIG. 23(b).

FIG. 26 is an explanatory diagram showing one example (Specific Example 11) of massaging steps when the gas-type massage device is fitted to the right arm in the gas-type massage apparatus according to the second embodiment.

FIG. 27 is an explanatory diagram showing one example (Specific Example 12) of massaging steps when the gas-type massage device is fitted to the right arm in the gas-type massage apparatus according to the second embodiment.

FIG. 28(a) is a schematic view when the gas-type massage device is fitted to the left arm and (b) is an explanatory diagram showing one example (Specific Example 13) of massaging steps at that time in the gas-type massage apparatus according to the second embodiment.

FIG. 29 is an explanatory diagram showing one example (Specific Example 14) of massaging steps when the gas-type massage device is fitted to the left arm in the gas-type massage apparatus according to the second embodiment.

FIG. 30 is an explanatory diagram showing one example (Specific Example 15) of massaging steps when the gas-type massage device is fitted to the left arm in the gas-type massage apparatus according to the second embodiment.

### DETAILED DESCRIPTION

Below, a gas-type massage apparatus according to embodiments of the invention will be described with reference to the attached drawings. Besides, embodiments shown below are merely exemplary, so that the gas-type massage apparatus of the invention is not limited to the examples below.

Besides, in the specification, “an A shape” and an expression similar thereto are to make a reference to not only a complete A shape but to make a reference including a shape suggesting the A shape in appearance (a shape being substantially A). Moreover, in the specification, “adjacent” and an expression similar thereto are to refer to not only ends of two or more articles being in mutual contact, but also the ends of two or more articles mutually overlapping, or the ends of two or more articles not being in mutual contact but being positioned in their mutual vicinity.

In the specification, “an axial direction” is to refer to a direction in which upper limbs or lower limbs of a human body, to which upper limbs or the lower limbs the gas-type massage device is fitted, extend from its trunk, “a peripheral direction” is to refer to a direction to go around the axial direction, and “a radial direction” is to refer to a direction to cross the axial direction (more specially, a direction being perpendicular to the axial direction). In the specification, “proximal” and an expression similar thereto are to refer, unless otherwise noted, to a side of the human body being closer to its heart, and “distal” and an expression similar thereto are to refer, unless otherwise noted, to a side being opposite to the “proximal”, which side is farther from the heart of the human body. In the specification, “upper” and an expression similar thereto are to refer to a side of the human body, which side is oriented to its head from their toes, and “lower” and an expression similar thereto are to refer to a side of the human body, which side is opposite to the “upper” and is oriented from the head to the toes. In the specification, “front (anterior)” and an expression similar thereto are to refer to a side of the human body to which its abdomen is oriented, and “rear (back)” and an expression similar thereto are to refer to a side being opposite to the “front (anterior)”, to which side of the human body their waists of are oriented. In the specification, “right” and an expression similar thereto are to refer to the left side when the human body is viewed from the front (anterior), and “left” and an expression similar thereto are to refer to a side being opposite to the “right” and being oriented to the right side when the human body is viewed from the front (anterior). In the specification, “inner” and an expression similar thereto are to refer to a side on which left and right legs face each other, and “outer” and an expression similar thereto are to refer to a side being opposite to the “inner”, on which side the left and right legs do not face each other.

In the specification, “lower limbs” and “legs” are to refer to parts from a crotch to the toes (the entire side being distal from the trunk), and “the feet” are to refer to parts from ankles to the toes (the entire side being distal from the ankles). In the specification, “upper limbs” and “arms” are to refer to parts from shoulders to fingertips (the entire side being distal from the shoulders), and “hands” are to refer to parts from the wrists to the fingertips (the entire side being distal from the wrists).

[First Embodiment]

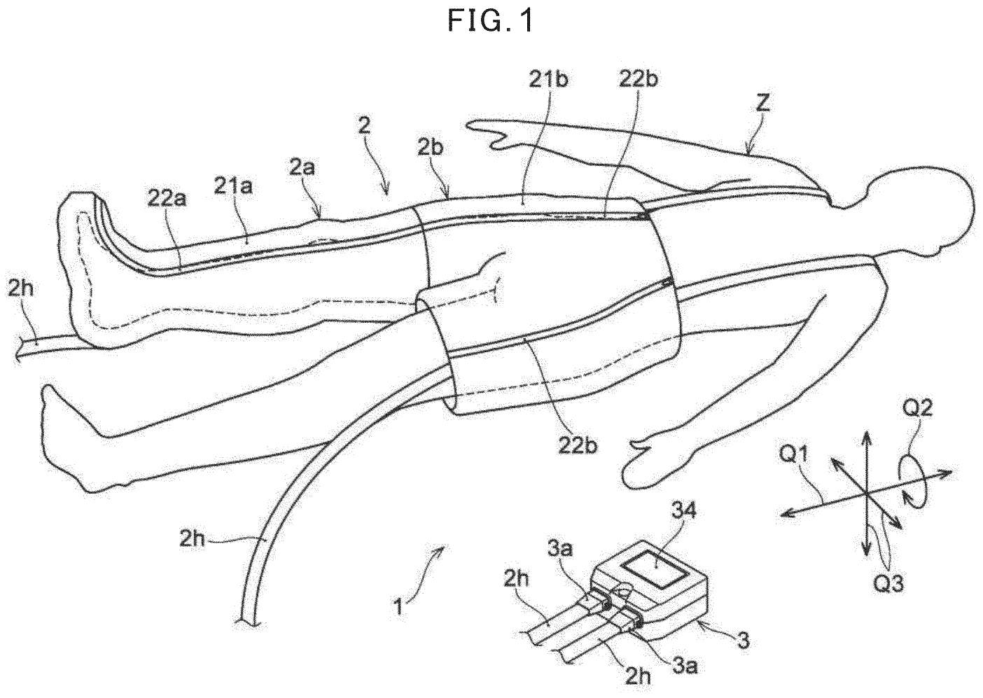

FIG. 1 shows a gas-type massage apparatus 1 according to a first embodiment. The gas-type massage apparatus 1 according to the embodiment is an apparatus to administer a massage to a human body Z using a high-pressure gas. The gas-type massage apparatus 1 is used to provide stimulus to the human body Z of the subject, such as “massaging” the human body Z of the subject, with an aim to improve a state of the human body Z, such as to remedy building up of body fluid of the subject and promote the flow thereof, for example. Here, in the specification, “a high-pressure gas” refers to gas having an air pressure higher than the atmospheric pressure. In the embodiment, the gas is air from a viewpoint of convenience. However, the gas is not particularly limited, so that it can be an inert gas such as He (helium), N2 (nitrogen), and the like, or a different gas such as O2 (oxygen) and the like. Besides, in the embodiment, the gas-type massage apparatus 1 provides stimulus to the human body Z of the subject to improve building up of lymph fluid of the subject. However, the gas-type massage apparatus 1 can provide stimulus to the human body Z of the subject to improve building up of body fluid being different, such as blood and the like of the subject.

As shown in FIG. 1, the gas-type massage apparatus 1 comprises a gas-type massage device 2 and a gas supply/discharge system 3.

The gas-type massage device 2 is a device to administer a massage to the human body Z using a high-pressure gas. As shown in FIG. 1, the gas-type massage device 2 is fluidly connected to the gas supply/discharge system 3 via a hose 2h. The gas-type massage device 2 expands with a high-pressure gas being received from the gas supply/discharge system 3, and contracts with a high-pressure gas being discharged via the gas supply/discharge system 3. The gas-type massage device 2 applies pressure on the human body Z through expansion and releases application of pressure on the human body Z through contraction. The gas-type massage device 2 massages the human body Z by repeating application of pressure on and release of application of pressure on the human body Z.

The gas-type massage device 2 is fitted to at least one part of upper limbs or lower limbs of the human body Z along an axial direction Q1 so as to surround the at least one part of the upper limbs or the lower limbs of the human body Z in a peripheral direction Q2. Besides, the “(at least) one part (of the upper limbs or the lower limbs of the human body Z)” can be the entirety of one limb (one arm or one leg) of the four limbs or a part of the one limb. As shown in FIG. 1, in the embodiment, the gas-type massage device 2 has a shape following at least a part of the legs of the human body Z. More specifically, as described below, the gas-type massage device 2 comprises a first gas-type massage device 2a having a boot shape following the one leg of the human body Z and a second gas-type massage device 2b having a half-trousers shape following the part above the crotch of the human body Z, and the first gas-type massage device 2a and the second gas-type massage device 2b are provided as separate pieces. In this way, in such a case of configuring the gas-type massage device 2 with the separate first and second massage devices 2a, 2b, it is made possible to separately fit the first and second massage devices 2a, 2b to the one leg, and the part above the crotch of the human body Z, respectively, making it easy to fit the gas-type massage device 2 to the human body Z. Moreover, in such a case of fitting the first gas-type massage device 2a to the left and right leg interchangeably, it is made possible to administer a massage to both the left and right halves in the lower limbs of the human body Z using the one gas-type massage device 2. Note that the gas-type massage device 2 can be composed of only the first gas-type massage device 2a. Moreover, the first gas-type massage device 2a can be formed as a gas-type massage device dedicated to the right leg or a gas-type massage device dedicated to the left leg such that it accurately follows the right leg or left leg.

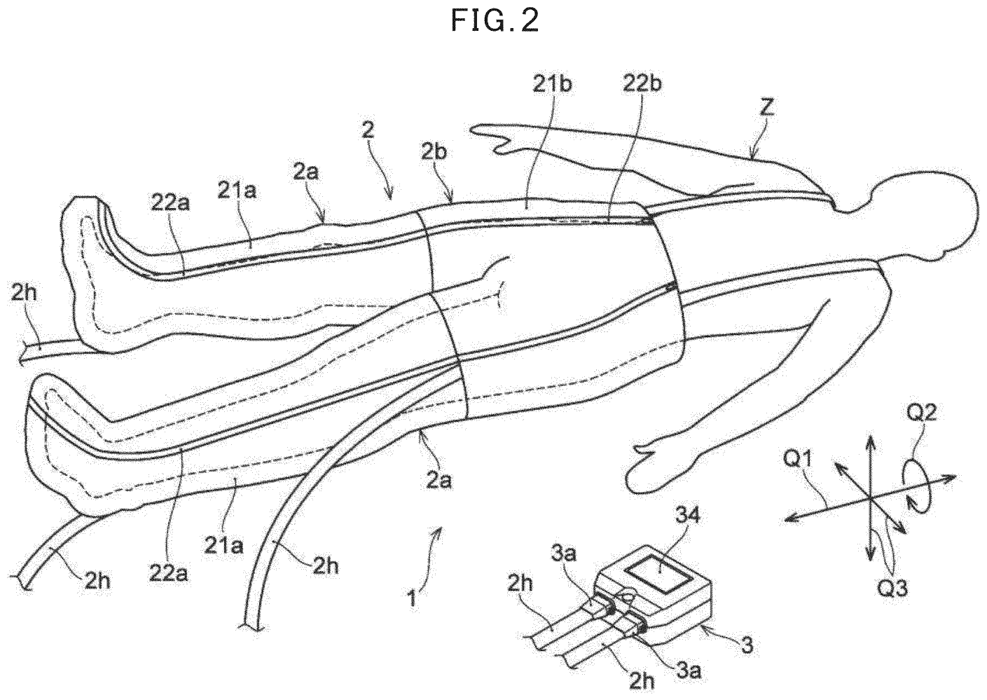

Besides, as in a variation shown in FIG. 2, the gas-type massage device 2 can comprise the first gas-type massage device 2a, 2a and the second gas-type massage device 2b. In this way, in such a case of providing the first gas-type massage device 2a, 2a in one pair, it is made possible to simultaneously fit the first gas-type massage device 2a, 2a to both of the legs of the human body Z to simultaneously administer a massage to both of the legs of the human body Z. Note that the gas-type massage device 2 is not limited to the form shown in FIGS. 1 and 2. For example, as described below, the gas-type massage device 2 can have a shape following the one arm of the human body Z. Moreover, the gas-type massage device 2 can have a shape of trousers being integrally formed so as to follow both of the left and right legs, and the waists to administer a massage to the entire lower half of the human body Z, or can have a shape of full body suits being integrally formed so as to follow both of the left and right legs, the waists, and the upper half of the human body to administer a massage to the general entirety of the human body Z.

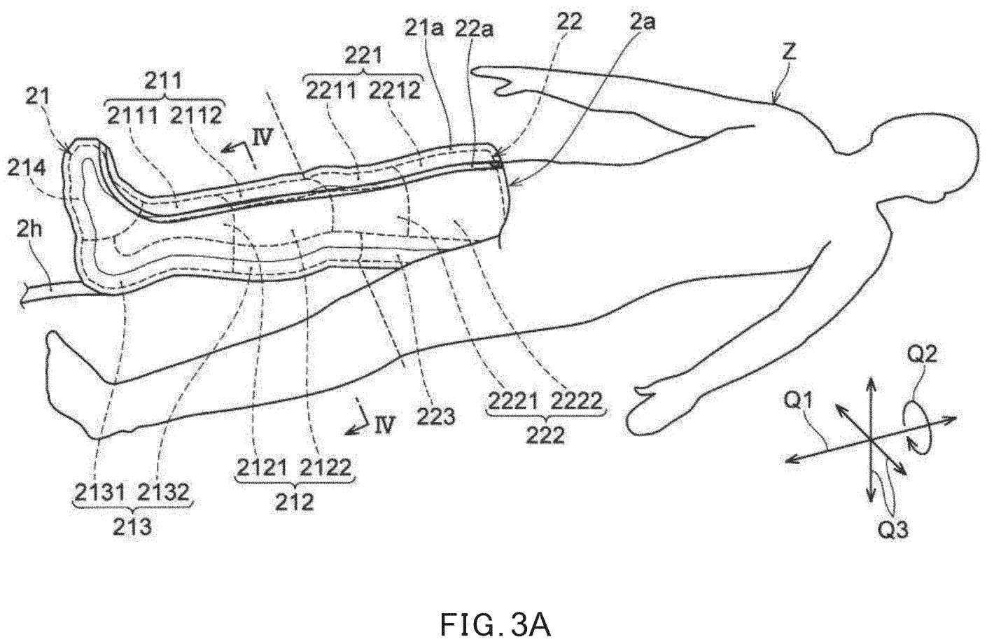

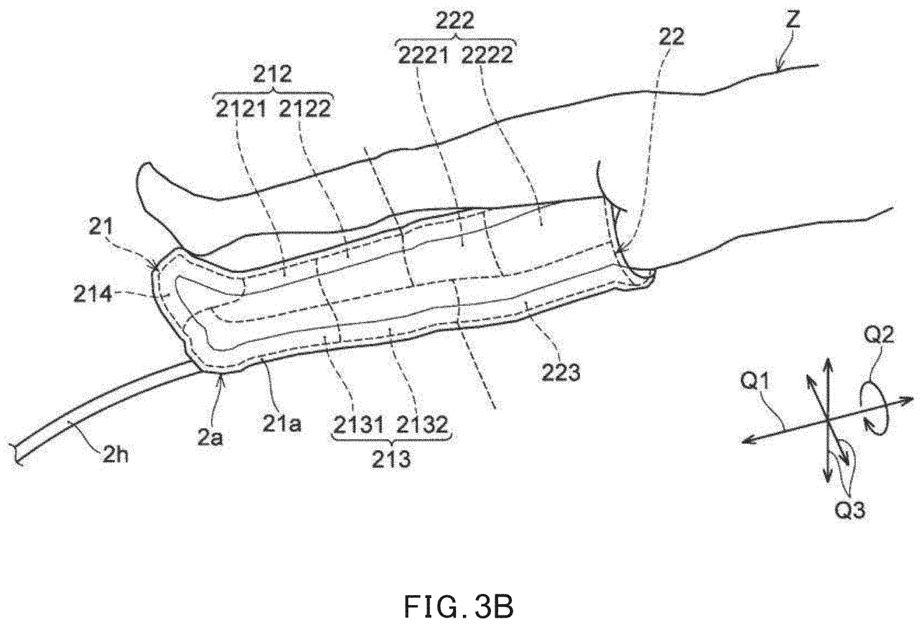

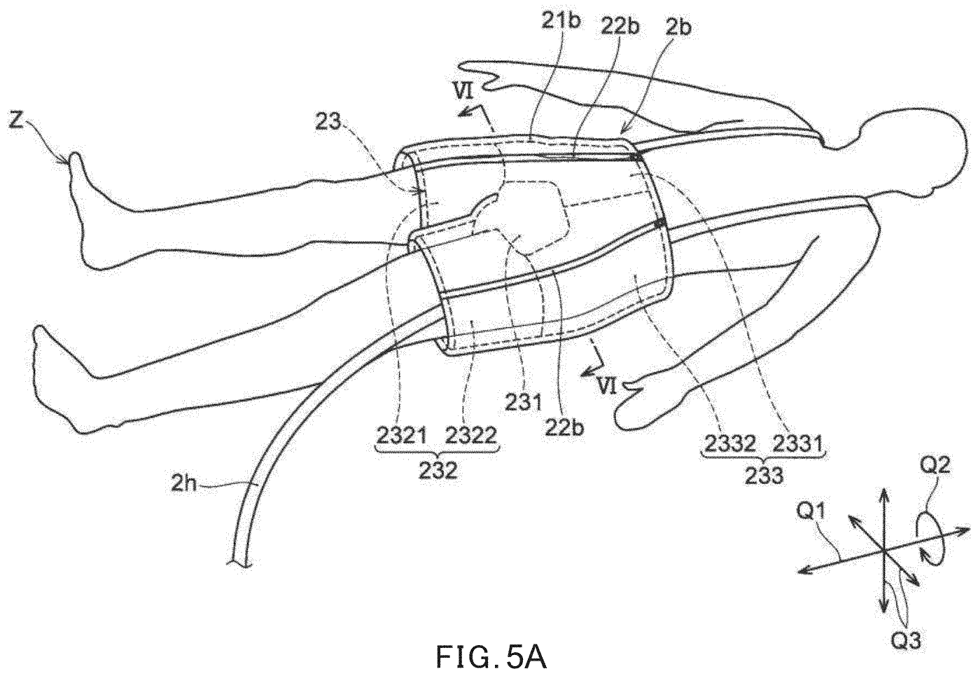

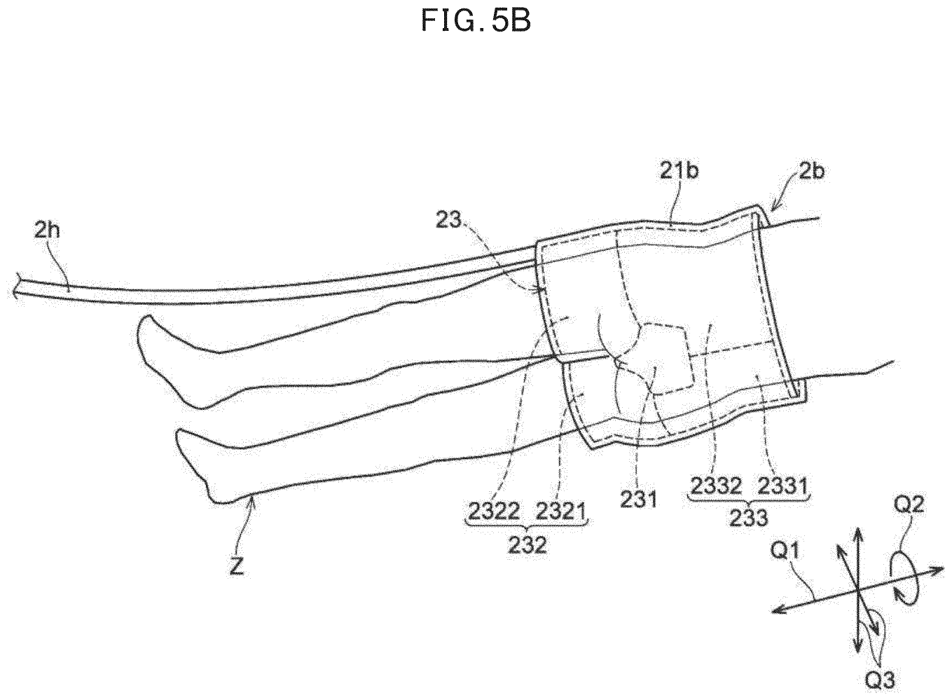

As shown in FIGS. 3A and 3B and FIGS. 5A and 5B individually showing the first gas-type massage device 2a and the second gas-type massage device 2b, the gas-type massage device 2 has a plurality of gas chambers that can receive and discharge a high-pressure gas to expand and contract mutually independently. The plurality of gas chambers comprise a first gas chamber group 21 and a second gas chamber group 22 being provided so as to be mutually adjacent in the axial direction Q1 (below, “the gas-type massage device 2” can also be expressed as “the gas-type massage device 2a, 2b”). Besides, in FIGS. 3A and 3B and FIGS. 5A and 5B, the human body Z being inserted into the gas-type massage device 2a, 2b is drawn with a solid line for ease of viewing the figures. In the embodiment, the plurality of gas chambers further comprise a third gas chamber group 23 (see FIGS. 5A and 5B) so as to be mutually adjacent to the second gas chamber group 22 in the axial direction Q1 (a side being opposite to a side adjacent to the first gas chamber group 21). Besides, in the specification, “a gas chamber group” refers to a gas chamber or a collection of gas chambers to be positioned at a position corresponding to a specific part of the human body Z, so that the number of gas chambers comprised in the gas chamber group can be one or can be a plurality. Besides, the third gas chamber group 23 does not necessarily have to be provided. Moreover, the plurality of gas chambers can comprise four or more gas chamber groups.

The corresponding relationship between the first gas-type massage device 2a and the second gas-type massage device 2b and the first to third gas chamber groups 21 to 23 can be appropriately changed in view of the ease of fitting of the gas-type massage device 2a, 2b. In the embodiment, the first gas-type massage device 2a has the first gas chamber group 21 and the second gas chamber group 22 as shown in FIGS. 3A and 3B, and the second gas-type massage device 2b has the third gas chamber group 23 as shown in FIGS. 5A and 5B. Note that the first gas-type massage device 2a can have a half of the first gas chamber group 21 and the second gas chamber group 22, and the second gas-type massage device 2b can have the remaining half of the second gas chamber group 22 and the third gas chamber group 23. Moreover, for example, the gas-type massage device 2a, 2b can further have a third massage device (not shown), the first gas-type massage device 2a can have the first gas chamber group 21, the second gas-type massage device 2b can have the second gas chamber group 22, and the third gas-type massage device can have the third gas chamber group 23.

As shown in FIGS. 3A and 3B, the first gas-type massage device 2a is fitted to the leg of the human body Z along the axial direction Q1 so as to surround the leg of the human body Z in the peripheral direction Q2. As long as the first gas-type massage device 2a can be fitted to the leg(s) of the human body Z, the shape thereof is not particularly limited. In the embodiment, the first gas-type massage device 2a has a boot shape and is bent (to the anterior side) with respect to the axial direction Q1 such that one end in the axial direction Q1 follows up to the toe at the end of the leg of the human body Z. In this way, when the first gas-type massage device 2a is fitted to the leg so to make a bent portion follow the toe, it is appropriately positioned with respect to the human body Z, making it possible to position a gas chamber at a desired part of the human body. Note that the first gas-type massage device 2a can have a different shape such as a simple cylindrical shape and the like.

In the embodiment, as shown in FIGS. 3A and 3B, the first gas-type massage device 2a has a plurality of gas chambers, a first cover 21a to surround the plurality of gas chambers in the peripheral direction Q2, and a first fastening device 22a (see FIG. 3A) to fasten together ends of the first cover 21a in the peripheral direction Q2. Specifically, as the plurality of gas chambers, the first gas-type massage device 2a has the first gas chamber group 21 and the second gas chamber group 22.

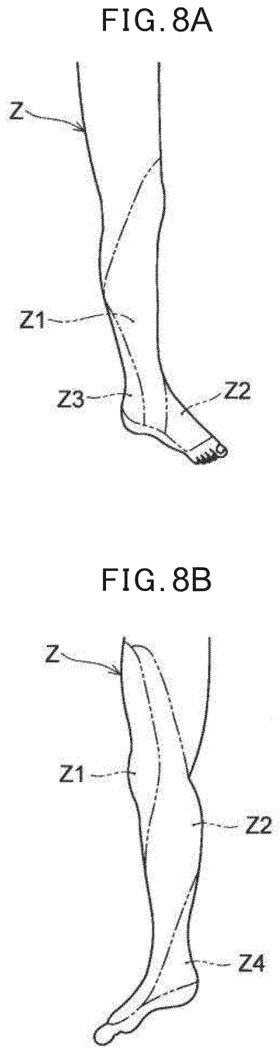

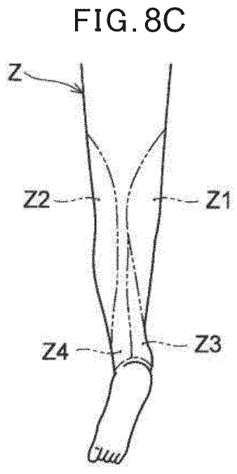

As shown in FIG. 3A, the first and second gas chamber groups 21, 22 have at least two gas chambers, respectively, along the peripheral direction Q2. In this way, in such a case that the first and second gas chamber groups 21, 22 have the at least two gas chambers along the peripheral direction Q2, it is made possible to expand the first gas-type massage device 2a only at a position at which pressure is to be applied on the first gas-type massage device 2a in the peripheral direction Q2 while avoiding a specific part of the human body Z. In the embodiment, the first gas chamber group 21 has a first gas chamber of first group 211 and a second gas chamber of first group 212 along the peripheral direction Q2. More specifically, the first gas chamber group 21 further has a third gas chamber of first group 213 between the first gas chamber of first group 211 and the second gas chamber of first group 212 along the peripheral direction Q2. Moreover, in the embodiment, the second gas chamber group 22 has a first gas chamber of second group 221 and a second gas chamber of second group 222 along the peripheral direction Q2. More specifically, the second gas chamber group 22 further has a third gas chamber of second group 223 between the first gas chamber of second group 221 and the second gas chamber of second group 222 along the peripheral direction Q2. As described below, this makes it easy to position each of the gas chambers of the first and second gas chamber groups 21, 22 such that it corresponds to a position of lymph vessel groups (see lymph vessel groups Z1 to Z4 in FIGS. 8A to 8C) in an interior of the human body Z. Note that the number of gas chambers comprised by the first and second gas chamber groups 21, 22, respectively, is not particularly limited as long as it does not adversely affect a massage by the gas-type massage device 2 (the first gas-type massage device 2a), and the like. For example, the first and second gas chamber groups 21, 22 can have four or more gas chambers, respectively, along the peripheral direction Q2.

As shown in FIG. 3A, each of the gas chambers 211, 212, 221, 222 of the first and second gas chamber groups 21, 22 can be divided in the axial direction Q1 into a plurality of gas sub-chambers that can expand and contract mutually independently. In this way, the flow of lymph fluid is further promoted when each of the gas chambers 211, 212, 221, 222 is gradually expanded along the axial direction Q1 to apply pressure on the human body Z in accordance with the number of divisions of each of the gas chambers 211, 212, 221, 222. Specifically, the first gas chamber of first group 211 can be divided into a first distal gas chamber of first group 2111 and a first proximal gas chamber of first group 2112 in the axial direction Q1. Moreover, the second gas chamber of first group 212 can be divided into a second distal gas chamber of first group 2121 and a second proximal gas chamber of first group 2122 in the axial direction Q1. Furthermore, the third gas chamber of first group 213 can be divided into a third distal gas chamber of first group 2131 and a third proximal gas chamber of first group 2132 in the axial direction Q1. Similarly, the first gas chamber of second group 221 can be divided into a first distal gas chamber of second group 2211 and a first proximal gas chamber of second group 2212 in the axial direction Q1. Moreover, the second gas chamber of second group 222 can be divided into a second distal gas chamber of second group 2221 and a second proximal gas chamber of second group 2222 in the axial direction Q1. Besides, the third gas chamber of second group 223 remains to be one gas chamber in FIG. 3A, not being divided in the axial direction Q1, but can be divided in the axial direction Q1 in the same manner as the other gas chambers of the first and second gas chamber groups 21, 22. The number of divisions of each of the gas chambers 211, 212, 211, 222 of the first and second gas chamber groups 21, 22 is not particularly limited. For example, each of the gas chambers of the first and second gas chamber groups 21, 22 can be divided into three or more, or the individual gas chambers can be divided into mutually different numbers.

Separately from the above-described gas chambers, the first and second gas chamber groups 21, 22 can have only a single one gas chamber being provided in the peripheral direction Q2 at an arbitrary position in the axial direction Q1. In the embodiment, as shown in FIGS. 3A and 3B, the first gas chamber group 21 has an end gas chamber of first group 214 over substantially the entire periphery in the peripheral direction Q2 so as to be adjacent to the first gas chamber of first group 211 and the second gas chamber of first group 212 (and the third gas chamber of first group 213) in the axial direction Q1 (on a side being opposite to a side adjacent to the second gas chamber group 22). Note that the second gas chamber group 22 can have a gas chamber over substantially the entire periphery in the peripheral direction Q2. Besides, the gas chamber over substantially the entire periphery in the peripheral direction Q2 does not necessarily have to be provided.

As long as the first and second gas chamber groups 21, 22 are positioned at one or more parts of the upper limbs or lower limbs of the human body Z, respectively, the positional relationship between the first and second gas chamber groups 21, 22, and the human body Z is not particularly limited. In the embodiment, as shown in FIGS. 3A and 3B, the first gas-type massage device 2a being fitted to the human body Z such that a bent portion of the first gas-type massage device 2a corresponds to a foot of the human body Z allows the first and second gas chamber groups 21, 22 to be positioned with respect to a lower thigh and upper thigh of the human body Z in the axial direction Q1 and the peripheral direction Q2. In this way, the first gas chamber of first group 211 is positioned at a position corresponding to an outer side of the lower thigh (an outer lower thigh) of the human body Z, the second gas chamber of first group 212 is positioned at a position corresponding to an inner side of the lower thigh (an inner lower thigh) of the human body Z, the first gas chamber of second group 221 is positioned at a position corresponding to an outer side of the upper thigh (an outer thigh) of the human body Z, and the second gas chamber of second group 222 is positioned at a position corresponding to an inner side of the upper thigh (an inner thigh (a vicinity of the groin)) of the human body Z. Moreover, in the embodiment, the third gas chamber of first group 213 is positioned at a position corresponding to a backside of the lower thigh (a rear surface of the lower thigh) of the human body Z and the third gas chamber of second group 223 is positioned at a position corresponding to a backside of the upper thigh (a rear surface of the thigh) of the human body Z. Furthermore, in the embodiment, the end gas chamber of first group 214 is positioned at a position corresponding to the foot of the human body Z. Note that a position with respect to the human body Z of the first and second gas chamber groups 21, 22 can be changed appropriately in accordance with the part of the human body Z, to which part a massage is to be administered.

Besides, the first gas-type massage device 2a is positioned at the leg of the human body Z by means of the end gas chamber of first group 214 in the embodiment, but can be positioned at the leg of the human body Z by means of a different positioning element. For example, the first gas-type massage device 2a can be positioned at the leg of the human body Z by coupling with the second gas-type massage device 2b by means of a fastener such as a button and the like when it is fitted to the human body Z.

The positional relationship of the gas chambers in the peripheral direction Q2 between the first gas chamber group 21 and the second gas chamber group 22 is not particularly limited as long as the gas chambers are mutually adjacent. In the embodiment, as shown in FIG. 3A, the first gas chamber of first group 211 and the first gas chamber of second group 221 are provided so as to be mutually adjacent in the axial direction Q1 and, more specifically, are provided so as to be mutually aligned in the axial direction Q1. Moreover, in the embodiment, the second gas chamber of first group 212 and the second gas chamber of second group 222 are provided so as to be mutually adjacent in the axial direction Q1 and, more specifically, are provided so as to be mutually aligned in the axial direction Q1. Moreover, in the embodiment, the third gas chamber of first group 213 and the third gas chamber of second group 223 are provided so as to be mutually adjacent in the axial direction Q1 and, more specifically, are provided so as to be mutually aligned in the axial direction Q1. In this way, the individual gas chambers of the first and second gas chamber groups 21, 22 are substantially lined up along the axial direction Q1, making it easy to position the individual gas chambers of the first and second gas chamber groups 21, 22 with respect to the human body Z so as to correspond to the extending direction of the lymph vessel groups (see the lymph vessel groups Z1 to Z4 in FIGS. 8A to 8C) in the interior of the human body Z. Therefore, due to expanding and contracting the individual gas chambers of the first gas-type massage device 2a so as to follow the extending direction of the lymph vessel group, it is made easy for lymph fluid to flow. However, in the axial direction Q 1 , neither of the gas chambers of the first gas chamber group 21 and the gas chambers of the second gas chamber group 22 has to mutually align, or possibly, one part thereof aligns while the other part thereof does not align.

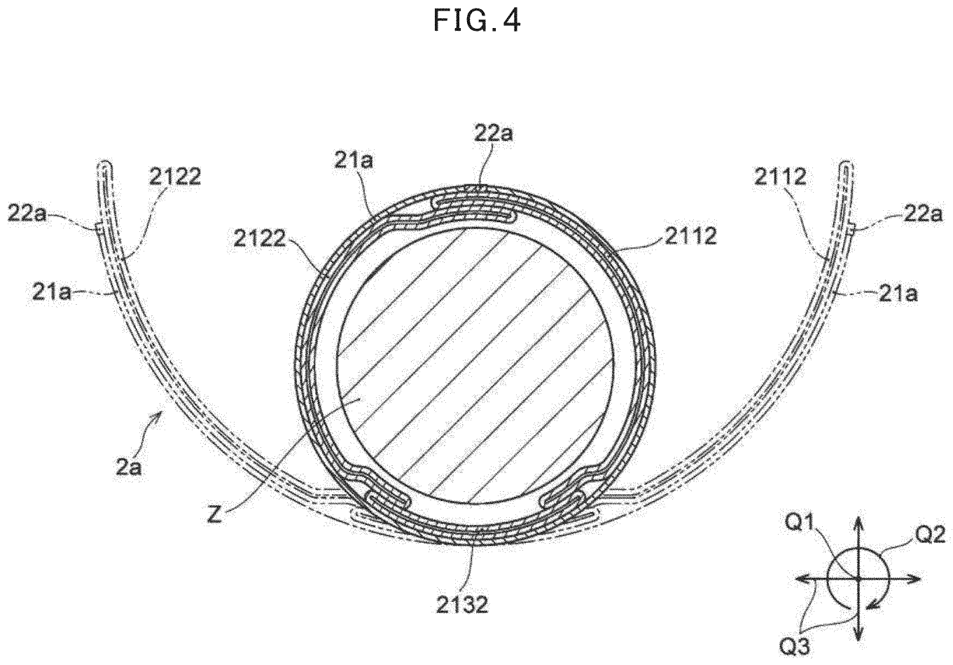

The positional relationship of the gas chambers in the peripheral direction Q2 in each of the first and second gas chamber groups 21, 22 is not particularly limited. In the embodiment, as shown in FIG. 4, the gas chambers of the first gas chamber group 21 have the ends thereof in the peripheral direction Q2 mutually overlapping (In FIG. 4 are shown, as the gas chambers of the first gas chamber group 21, the first proximal gas chamber of first group 2112, the second proximal gas chamber of first group 2122, and the third proximal gas chamber of first group 2132.) In this case, the gas chambers of the first gas chamber group 21 are arranged without gaps in the peripheral direction Q2, so that, when all of the gas chambers of the first gas chamber group 21 expand, pressure can be applied on the human body Z exhaustively in the peripheral direction Q2. Moreover, while not particularly shown, in the embodiment, in the same manner as the gas chambers of the first gas chamber group 21, the gas chambers of the second gas chamber group 22 have the ends thereof in the peripheral direction Q2 mutually overlapping. Note that, in each of the first and second gas chamber groups 21, 22, the gas chambers do not have to overlap mutually, so that they can be provided so as to be in mutual separation.

As shown in FIGS. 3A to 4, in the embodiment, the first cover 21a has a sheet-like shape. The first cover 21a is not particular limited in size thereof as long as it can cover the first and second gas chamber groups 21, 22 when the first gas-type massage device 2a is fitted to the human body Z. For example, the first cover 21a is formed to have a peripheral length being one size greater than the average peripheral length of the human body Z (the leg of the human body Z). Moreover, the first cover 21a is not particularly limited in material thereof as long as it can deform in accordance with a shape of the human body Z (the leg of the human body Z), and has a strength that can suppress expansion to the outer side in the radial directions Q3 of the first and second gas chamber groups 21, 22 when the first and second gas chamber groups 21, 22 expand. The first cover 21a can be formed with a synthetic fiber, for example.

As shown in FIG. 4, the first fastening device 22a is provided to fasten together the ends of the first cover 21a in the peripheral direction Q2. In such a case that the ends of the first cover 21a are fastened together with the first fastening device 22a, it is made possible to close the unfolded first gas-type massage device 2a (see chain double-dashed lines in FIG. 4) in a cylindrical shape. This makes it possible to fit the first gas-type massage device 2a to the human body Z (the leg of the human body Z) after it is unfolded, making it easy to fit the first gas-type massage device 2a to the human body Z (the leg of the human body Z). In the embodiment, the first fastening device 22a is provided along the axial direction Q1 at both ends of the first cover 21a in the peripheral direction Q2, and one end and the other end of the first cover 21a in the peripheral direction Q2 are fastened on the anterior side of the human body Z (the leg of the human body Z). In this way, with the first gas-type massage device 2a being unfolded, the first gas-type massage device 2a can be fitted to the human body Z (the leg of the human body Z) so as to surround it after placing the human body Z (the leg of the human body Z) at the center on the left and right of the first gas-type massage device 2a. Therefore, it is made easy for the first gas-type massage device 2a to be fitted to the human body Z (the leg of the human body Z) even for the subject having difficulty moving the lower limbs, for example. Moreover, in the embodiment, the first cover 21a is provided with the first fastening device 22a such that, when the first gas-type massage device 2a is unfolded, the first gas chamber of first group 211 (the first proximal gas chamber of first group 2112 of the first gas chamber of first group 211 is shown in FIG. 4) and the second gas chamber of first group 212 (the second proximal gas chamber of first group 2122 of the second gas chamber of first group 212 is shown in FIG. 4) extend on a side being outer in the peripheral direction Q2 with respect to both ends of the first cover 21a (see the chain double-dashed lines in FIG. 4). Therefore, the first fastening device 22a can fasten together the ends of the first cover 21a in the peripheral direction Q2 such that the ends of the first gas chamber of first group 211 and the second gas chamber of second group 212 in the peripheral direction Q2 mutually overlap (see solid lines in FIG. 4). Besides, the first fastening device 22a is a line fastener in FIG. 4, but it can be a different fastening device such as a plurality of buttons arranged in parallel in the axial direction Q1.

As shown in FIGS. 5A and 5B, the second gas-type massage device 2b is fitted along the axial direction Q1 so as to surround the surrounding of a crotch of the human body Z in the peripheral direction Q2. The second gas-type massage device 2b is not particularly limited in shape thereof as long as it can be fitted to the part above the crotch of the human body Z. In the embodiment, as shown in FIGS. 5A and 5B, the second gas-type massage device 2b has a half-trousers shape, comprises two openings on one end side in the axial direction Q1 so as to be inserted therethrough by the legs of the human body Z and comprises one opening on the other end side in the axial direction Q1 so as to be inserted therethrough by the waists of the human body Z. Note that the second gas-type massage device 2b can have a different shape such as a simple cylindrical shape and the like.

In the embodiment, as shown in FIGS. 5A and 5B, the second gas-type massage device 2b comprises at least one gas chamber, a second cover 21b to surround the at least one gas chamber in the peripheral direction Q2, and a second fastening device 22b to fasten together ends of the second cover 21b in the peripheral direction Q2. The second gas-type massage device 2b further has the third gas chamber group 23 as the at least one gas chamber.

In the embodiment, as shown in FIGS. 5A and 5B, the third gas chamber group 23 has a first gas chamber of third group 231 to be provided at a center on the left and right thereof, and a second gas chamber of third group 232 to be provided adjacent to both sides on left and right of the first gas chamber of third group 231 downward in the axial direction Q1. Specifically, the first gas chamber of third group 231 is formed in a curved band shape spanning the anterior side and the posterior side so as to correspond to a bifurcation into two openings on one end side of the half-trousers shape in the axial direction Q1. Specifically, the second gas chamber of third group 232 is formed in two independent cylindrical shapes so as to correspond to the two openings on one end side of the half-trousers shape in the axial direction Q1. The third gas chamber group 23 can further have a third gas chamber of third group 233 to be provided adjacent to the first gas chamber of third group 231 and the second gas chamber of third group 232 upward in the axial direction Q1. Specifically, the third gas chamber of third group 233 is formed in a shape of one cylinder so as to correspond to one opening on the other end side of the half-trousers shape in the axial direction Q1. Note that arrangement of the gas chambers of the third gas chamber group 23 can be appropriately changed in accordance with the content of administering a massage by the gas-type massage device 2 (the second gas-type massage device 2b).

As shown in FIGS. 5A and 5B, each of the gas chambers 231 to 233 of the third gas chamber group 23 can have a plurality of gas sub-chambers that can expand and contract mutually independently. Specifically, the second gas chamber of third group 232 can have a second right gas chamber of third group 2321 and a second left gas chamber of third group 2322 that correspond to independent cylindrical shapes on the left and right thereof on one end side in the axial direction Q1. Moreover, the third gas chamber of third group 233 can be divided into a third right gas chamber of third group 2331 and a third left gas chamber of third group 2332 respectively configuring a right half and a left half of one cylindrical shape on the other end side in the axial direction Q1. Note that the number of gas chamber divisions of the third gas chamber group 23 is not particularly limited and can be appropriately changed in accordance with the content of administering a massage by the gas-type massage device 2 (second gas-type massage device 2b).

The positional relationship between the third gas chamber group 23 and the human body Z is not particularly limited. In the embodiment, as shown in FIGS. 5A and 5B, fitting the second gas-type massage device 2b to the human body Z such that a bifurcation into two openings on one end side of the second gas-type massage device 2b in the axial direction Q1 corresponds to the crotch of the human body Z allows the third gas chamber group 23 to be positioned with respect to a part above the crotch in the axial direction Q1 and the peripheral direction Q2. In this way, the first gas chamber of third group 231 is positioned at a position of the human body Z, which position corresponds to a part from a center on left and right of the lower abdomen through the crotch to a center on left and right of the hips, and the second gas chamber of third group 232 is positioned at a position of the human body Z, which position corresponds to the upper thigh (the vicinity of the groin)) of the right leg and left leg. Moreover, the third gas chamber of third group 233 is positioned at a position of the human body Z, which position corresponds to the hips and the waists through the left and right flanks from the lower abdomen. Note that a position with respect to the human body Z of the third gas chamber group 23 can be changed appropriately in accordance with the part of the human body Z, to which part a massage is to be administered.

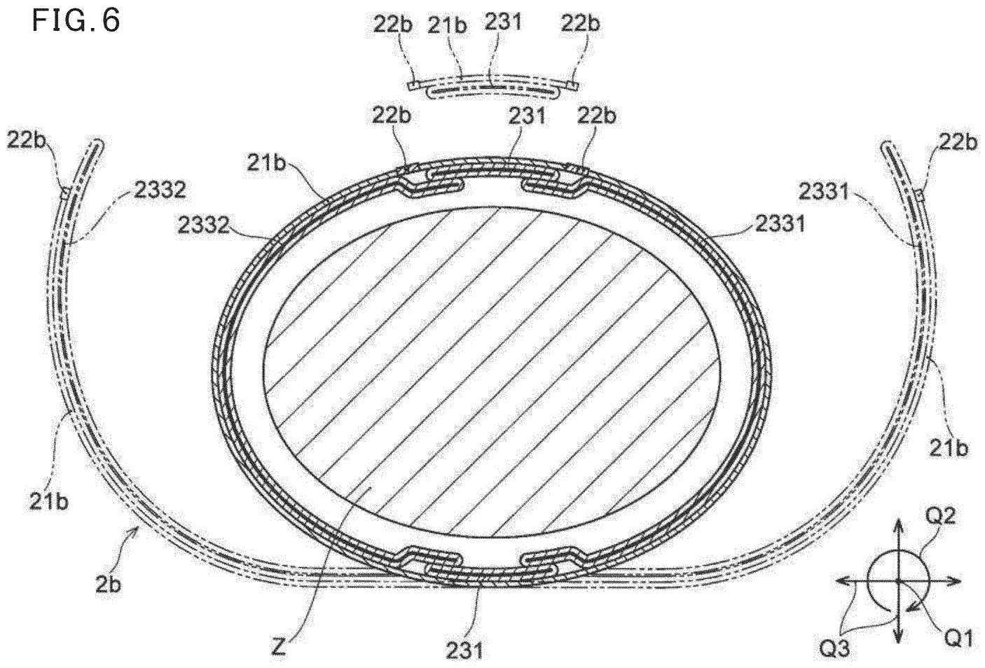

The positional relationship of the gas chambers in the peripheral direction Q2 in the third gas chamber group 23 is not particularly limited. In the embodiment, as shown in FIG. 6, the gas chambers of the third gas chamber group 23 have the ends thereof in the peripheral direction Q2 mutually overlapping (In FIG. 6 are shown, as the gas chambers of the third gas chamber group 23, the first gas chamber of third group 231, the third right gas chamber of third group 2331, and the third left gas chamber of third group 2332.) Note that the gas chambers in the third gas chamber group 23 do not have to overlap mutually, so that they can be provided so as to be in mutual separation.

As shown in FIGS. 5A to 6, in the same manner as the first cover 21a, the second cover 21b has a sheet-like shape. As shown in FIG. 6, the second fastening device 22b is provided to fasten together ends of the second cover 21b in the peripheral direction Q2. In the embodiment, the second fastening device 22b is provided in one pair along the axial direction Q1 on the anterior right side and anterior left side of the second cover 21b to fasten, on the anterior side of the human body Z, both ends at the anterior center of the second cover 21b in the peripheral direction Q2 and the end of the anterior right side and anterior left side in the peripheral direction Q2. Moreover, in the embodiment, the second cover 21b is provided with the second fastening device 22b such that, when the second gas-type massage device 2b is unfolded, the third gas chamber of third group 233 (the third right gas chamber of third group 2331 and the third left gas chamber of third group 2332 configuring the third gas chamber of third group 233 is shown in FIG. 6) extends on a side being outer in the peripheral direction Q2 with respect to the end of the second cover 21b (see the chain double-dashed lines in FIG. 6). Therefore, the second fastening device 22b can fasten together the ends of the second cover 21b in the peripheral direction Q2 such that the ends of the first gas chamber of third group 231 and the third gas chamber of third group 233 in the peripheral direction Q2 mutually overlap (see the solid lines in FIG. 6). Similarly, while not particularly shown, in the embodiment, the second cover 21b is provided with the second fastening device 22b such that, when the second gas-type massage device 2b is unfolded, the second gas chamber of third group 232 extends on a side being outer in the peripheral direction Q2 with respect to the end of the second cover 21b. Therefore, the second fastening device 22b can fasten together the ends of the second cover 21b in the peripheral direction Q2 such that the ends of the first gas chamber of third group 231 and the second gas chamber of third group 232 in the peripheral direction Q2 mutually overlap. The other aspects of the second cover 21b and the second fastening device 22b are similar to those of the first cover 21a and the first fastening device 22a, so that detailed explanations thereof will be omitted.

With reference to FIG. 1 again, the gas-type massage apparatus 1 comprises the gas supply/discharge system 3. The gas supply/discharge system 3 supplies a high-pressure gas to the plurality of gas chambers (see FIGS. 3A to 6) and discharges a high-pressure gas from the plurality of gas chambers of the gas-type massage device 2. In the embodiment, the gas supply/discharge system 3 is fluidly connected in a removable manner to the gas-type massage device 2 (specifically, the hose 2h of the gas-type massage device 2) via a connector 3a. This makes it possible for the gas-type massage apparatus 1 to select the gas-type massage device 2 in a variety, which gas-type massage device 2 corresponds to the parts, to which parts a massage is to be administered using the one gas supply/discharge system 3 by interchanging the gas-type massage device 2 to be fluidly connected to the gas supply/discharge system 3.

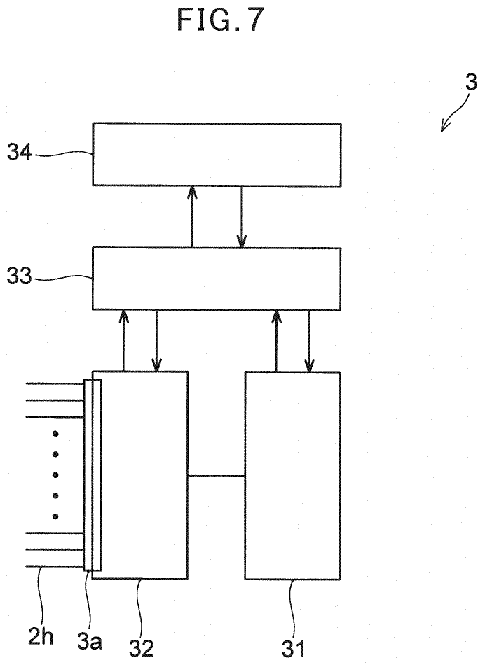

In the embodiment, as shown in FIG. 7, the gas supply/discharge system 3 comprises a gas supply apparatus 31 to supply a high-pressure gas, a flow path switching apparatus 32 to switch a flow path of a high-pressure gas, a control apparatus 33 to control the gas supply apparatus 31 and the flow path switching apparatus 32, and an operation part 34 to operate the gas supply/discharge system 3. Specifically, the control apparatus 33 controlling operations of the gas supply apparatus 31 and the flow path switching apparatus 32 based on an input to the operating part 34 of a user of the gas-type massage device 2 allows the gas supply/discharge system 3 to supply a high-pressure gas to the plurality of gas chambers (see FIGS. 3A to 6) and discharge a high-pressure gas from the plurality of gas chambers of the gas-type massage device 2. The gas supply apparatus 31, the flow path switching apparatus 32, the control apparatus 33, and the operation part 34 are not particularly limited in the specific configuration thereof as long as they can exhibit the above-mentioned functions. As the gas supply apparatus 31, a known air pump and the like can be used, for example. As the flow path switching apparatus 32, a known compressed air distributor in which a bifurcated tube and an electromagnetic valve are combined, and the like can be used, for example. As the control apparatus 33, a known controller and the like can be used, which known controller can control operations of the gas supply apparatus 31 and the flow path switching apparatus 32 based on control programs written to expand and contract the gas chambers in a desired order based on the below-described massaging steps to administer a massage, for example. As the operation part 34, a touch panel type display apparatus and the like can be used, for example. Note that, in a case that the order to expand the gas chambers is determined by the flow path in the gas-type massage device 2, as a result of fluid connections between the gas chambers, the order to expand one of which gas chambers precedes/follows the order to expand the other one of which gas chambers, the gas supply/discharge system 3 does not necessarily have to comprise the flow path switching apparatus 32, the control apparatus 33, or the operation part 34.

The gas supply/discharge system 3 can supply a high-pressure gas to the gas chambers and discharge a high-pressure gas from the gas chambers in various orders based on control programs. For example, to promote the flow of body fluid toward the trunk from the upper limbs or the lower limbs of the human body Z, the gas supply/discharge system 3 supplies a high-pressure gas to the first gas chamber group 21 and then supplies a high-pressure gas to the second gas chamber group 22. In the embodiment, it is intended that lymph fluid be passed toward the trunk from the lower limbs of the human body Z to alleviate symptoms of lymphedema of the lower limbs of the human body Z using the gas-type massage apparatus 1. As shown in FIGS. 8A to 8C, the lymph vessel groups Z1 to Z4 in the lower limbs of the human body Z are divided into the lymph vessel group Z1 on an outer anterior side of the legs, the lymph vessel group Z2 on an inner anterior side of the legs, the lymph vessel group Z3 on an outer posterior side of the legs (see FIGS. 8A and 8C), and the lymph vessel group Z4 on an inner posterior side of the legs (see FIGS. 8B and 8C). (In FIGS. 8A to 8C, letters Z1 to Z4 are affixed in regions, in the interior of which regions the individual lymph vessel groups are present). In a case of lymphedema in the lower limbs, in the initial condition of the disease, either one of the lymph vessel group Z1 on the outer anterior side and the lymph vessel group Z2 on the inner anterior side of the legs is often damaged. In this case, even when pressure is simply applied on regions of the human body Z, in the interior of which regions the damaged lymph vessel groups Z1, Z2 are present, it is difficult for lymph fluid to flow toward the trunk from the lymph vessel groups Z1, Z2.

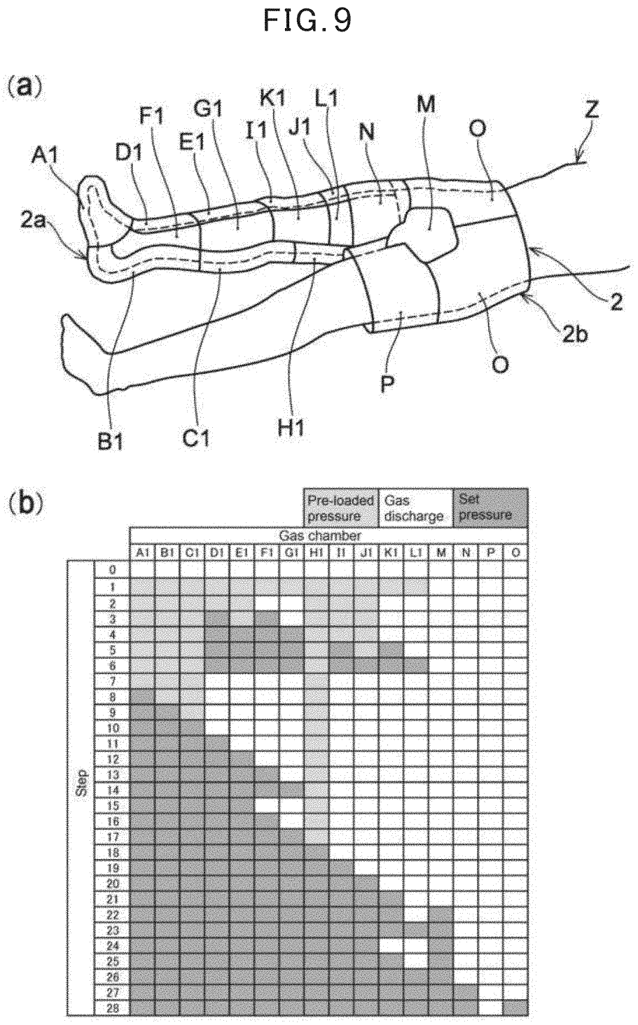

Then, in the embodiment, the order of supplying a high-pressure gas to the first and second gas chamber groups 21, 22 in the peripheral direction Q2 is appropriately changed to administer a massage to the human body Z. Below, with reference to FIGS. 9 to 20, an example of the order of supplying a high-pressure gas to the gas chambers and the order of discharging a high-pressure gas from the gas chambers (below called “massaging steps”) by the gas-type massage apparatus 1 according to the embodiment is described. In the explanations below, a state in which the vessels such as the lymph vessel are damaged can be called merely “abnormal”, and a state in which the vessels such as the lymph vessel are normal or have little damage can be called merely “normal”. Besides, the explanations below are merely exemplary, so that the massaging steps by means of the gas-type massage apparatus of the invention is not limited to the examples below.

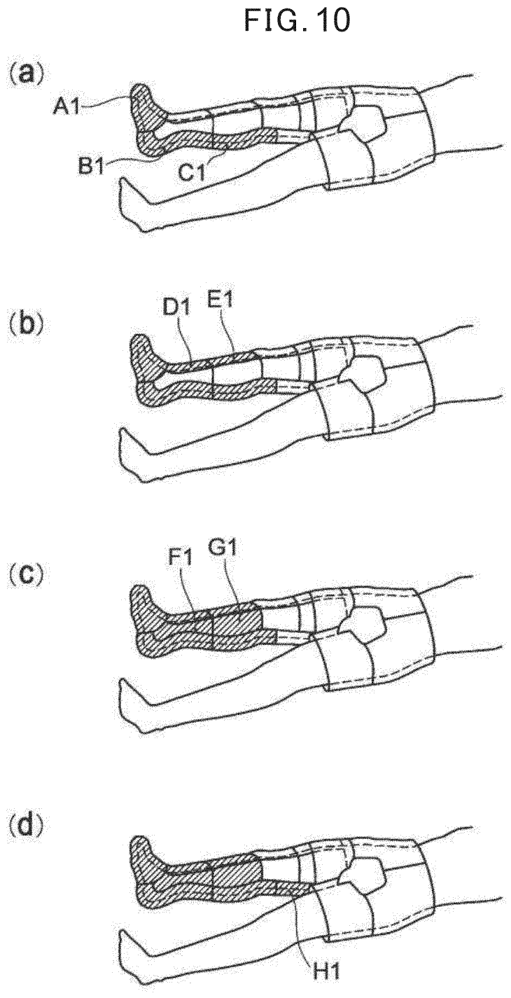

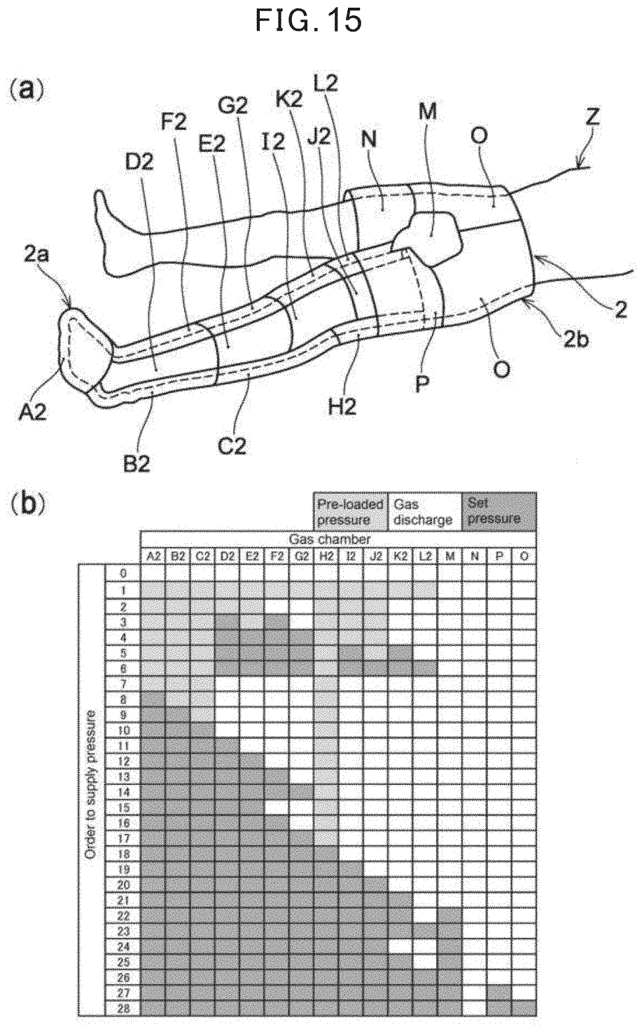

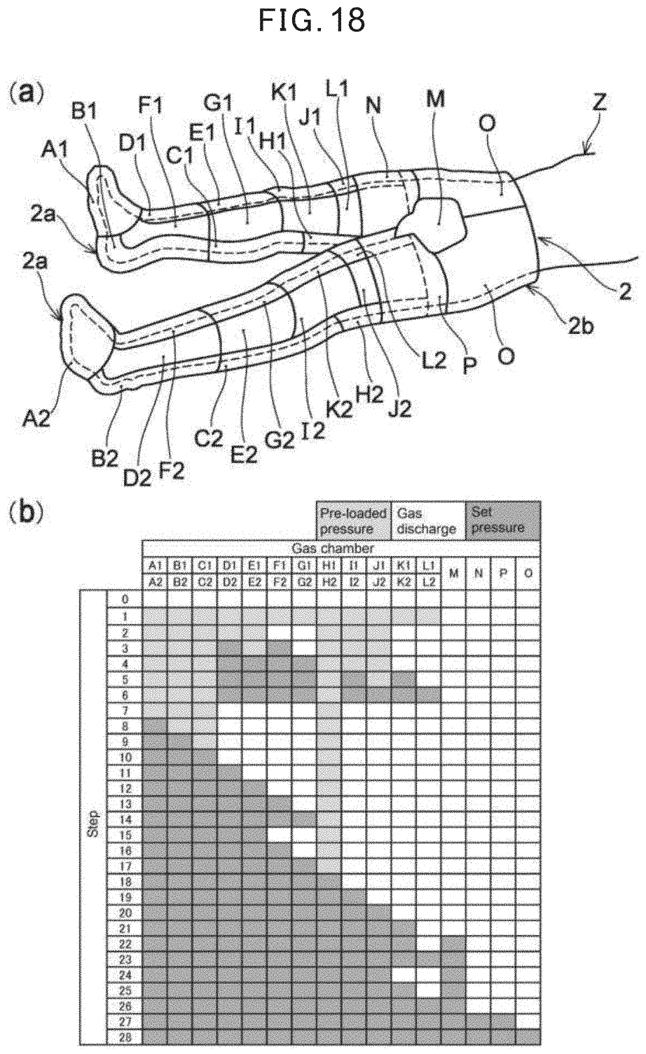

In the explanations below, for convenience of explanations, when the first gas-type massage device 2a is fitted to the right leg, letters for the gas chambers comprised in the first gas chamber group 21, “214, 2131, 2132, 2111, 2112, 2121, 2122” (see FIGS. 3A and 3B), are replaced by “A1, B1, C1, D1, E1, F1, G1” (see FIG. 9(a) and FIG. 18(a)), respectively. Moreover, letters for the gas chambers comprised in the second gas chamber group 22, “223, 2211, 2212, 2221, 2222” (see FIGS. 3A and 3B), are replaced by “H1, I1, J1, K1, L1” (see FIG. 9(a) and FIG. 18(a)), respectively. When the first gas-type massage device 2a is fitted to the left leg, letters for the gas chambers comprised in the first gas chamber group 21, “214, 2131, 2132, 2121, 2122, 2111, 2112” (see FIGS. 3A and 3B), are replaced by “A2, B2, C2, D2, E2, F2, G2” (see FIG. 15(a) and FIG. 18(a)), respectively. Moreover, letters for the gas chambers comprised in the second gas chamber group 22, “223, 2221, 2222, 2211, 2212” (see FIGS. 3A and 3B), are replaced by “H2, 12, J2, K2, L2” (see FIG. 9(a), FIG. 15(a), and FIG. 18(a)), respectively. Furthermore, letters for the gas chambers of the third gas chamber group 23, “231, 2321, 2331, 2332, 2322” (see FIGS. 5A and 5B), are replaced by “M, N, O, O, P” (see FIG. 9(a), FIG. 15(a), and FIG. 18(a)), respectively. Besides, in FIG. 9(a), FIGS. 10 to FIG. 12, FIG. 15(a), and FIG. 18(a), for ease of viewing the figures, the first cover 21a and the first fastening device 22a (see FIG. 1) of the first gas-type massage device 2a and the second cover 21b and the second fastening device 22b (see FIG. 1) of the second gas-type massage device 2b are not shown.

Besides, in the embodiment, the first gas-type massage device 2a is fitted to one of the right leg and the left leg, or both of the right leg and the left leg. At that time, in accordance with the part of the human body Z to be positioned at, names of the individual gas chambers of the first gas-type massage device 2a can be changed between a case in which the first gas-type massage device 2a is fitted to the right leg and a case in which the first gas-type massage device 2a is fitted to the left leg. For example, the first gas chamber of first group D1, E1 when the first gas-type massage device 2a is fitted to the right leg (see FIG. 9(a) and FIG. 18(a)) is called the second gas chamber of first group F2, G2 when the first gas-type massage device 2a is fitted to the left leg (see FIG. 15(a) and FIG. 18(a)), and, conversely, the second gas chamber of first group F1, G1 when the first gas-type massage device 2a is fitted to the right leg (see FIG. 9(a) and FIG. 18(a)) is called the first gas chamber of first group D2, E2 when the first gas-type massage device 2a is fitted to the left leg (see FIG. 15(a) and FIG. 18(a)). Moreover, the first gas chamber of second group I1, J1 when the first gas-type massage device 2a is fitted to the right leg (see FIG. 9(a) and FIG. 18(a)) is called the second gas chamber of first group K2, L2 when the first gas-type massage device 2a is fitted to the left leg (see FIG. 15(a) and FIG. 18(a)), and, conversely, the second gas chamber of second group K1, L1 when the first gas-type massage device 2a is fitted to the right leg (see FIG. 9(a) and FIG. 18(a)) is called the first gas chamber of second group I2, J2 when the first gas-type massage device 2a is fitted to the left leg (see FIG. 15(a) and FIG. 18(a)).

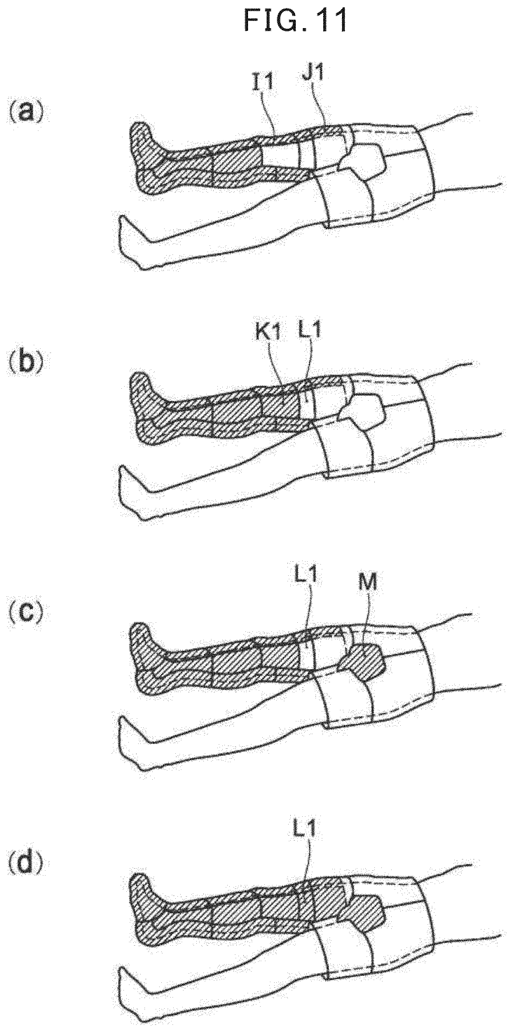

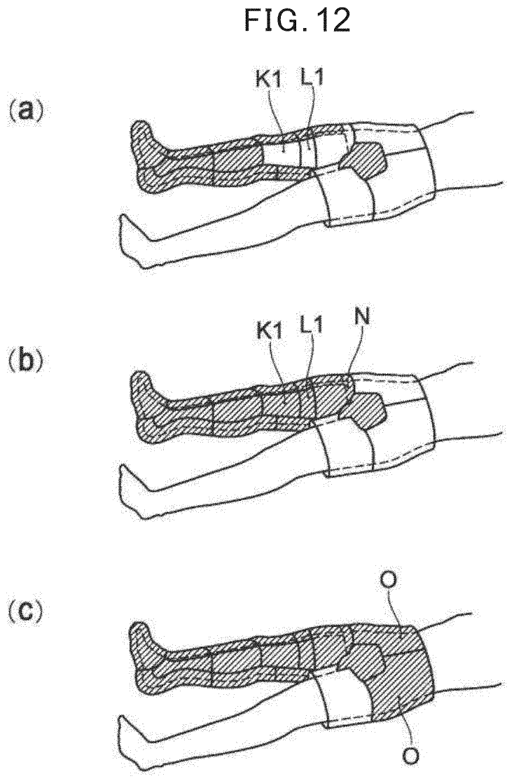

First, a case in which the first gas-type massage device 2a is fitted to the right leg is explained (Specific Examples 1 to 3). FIGS. 9 to 14 show examples (Specific Examples 1 to 3) in which the first gas-type massage device 2a is fitted to the right leg in the embodiment. FIG. 9(a) shows a position of each of the gas chambers when the first gas-type massage device 2a is fitted to the right leg. FIG. 9(b) shows, in order, Specific Example (Specific Example 1) of massaging steps when the first gas-type massage device 2a is fitted to the right leg, and FIG. 10 shows, in order, main steps of the massaging steps in FIG. 9(b). FIG. 11 shows, in order, another Specific Example (Specific Example 2) of massaging steps when the first gas-type massage device 2a is fitted to the right leg, and FIG. 12 shows, in order, yet another Specific Example (Specific Example 3) of massaging steps when the first gas-type massage device 2a is fitted to the right leg.

For example, in a case that the lymph vessel group Z1 on the outer anterior side of the right leg (see FIGS. 8A to 8C) is abnormal, in the embodiment, as shown in FIG. 9(b) and FIGS. 10 to 12 using letters respective for the gas chambers of FIG. 9(a), the gas supply/discharge system 3 supplies a high-pressure gas to the first gas chamber of first group D1, E1 (see steps 11 and 12 of FIG. 9(b), and FIG. 10(b)), the second gas chamber of first group F1, G1 (see steps 13 and 14 of FIG. 9(b), and FIG. 10(c)), the first gas chamber of second group I1, J1 (see steps 19 and 20 of FIG. 9(b), and FIG. 11(a)), and the second gas chamber of second group K1, L1 (see steps 21 and 23 of FIG. 9(b), and FIG. 11(d)) in that order. Then, first, the first gas chamber of first group D1, E1 applies pressure on the outer side of the lower thigh to guide lymph fluid from the outer side of the lower thigh to the inner side of the lower thigh so as to avoid the abnormal lymph vessel group Z1 (see FIG. 8A to FIG. 8C). Thereafter, the second gas chamber of first group F1, G1 applies pressure on the inner side of the lower thigh to guide lymph fluid being guided from the outer side of the lower thigh from the lower thigh to the upper thigh via the normal lymph vessel group Z2 (see FIGS. 8A to 8C). Subsequently, the first gas chamber of second group I1, J1 applies pressure on the outer side of the upper thigh to guide lymph fluid from the outer side of the upper thigh to the inner side of the upper thigh so as to avoid the abnormal lymph vessel group Z1. Thereafter, the second gas chamber of second group K1, L1 applies pressure on the inner side of the upper thigh to guide lymph fluid being guided from the outer side of the upper thigh and lymph fluid being guided from the lower thigh from the upper thigh to the trunk via the normal lymph vessel group Z2. This makes it easy for lymph fluid to flow from the lower limbs to the trunk of the human body Z even in a case that the abnormal lymph vessel group Z1 is present, making it easy to alleviate the symptoms of lymphedema.

The gas supply/discharge system 3 can supply a high-pressure gas to the third gas chamber of first group B1, C1 (see steps 9 and 10 of FIG. 9(b), and FIG. 10(a)), the first gas chamber of first group D1, E1 (see steps 11 and 12 of FIG. 9(b), and FIG. 10(b)), the second gas chamber of first group F1, G1 (see steps 13 and 14 of FIG. 9(b), and FIG. 10(c)), the third gas chamber of second group H1 (see step 18 of FIG. 9(b), and FIG. 10(d)), the first gas chamber of second group I1, J1 (see steps 19 and 20 of FIG. 9(b), and FIG. 11(a)), and the second gas chamber of second group K1, L1 (see steps 21 and 23 of FIG. 9(b), and FIG. 11(d)) in that order. Then, first, the third gas chamber of first group B1, C1 applies pressure on the backside of the lower thigh to suppress the inflow of lymph fluid into the lymph vessel group Z3, Z4 (see FIGS. 8A to 8C) on the backside of the legs. Thereafter, the first gas chamber of first group D1, E1 applies pressure on the outer side of the lower thigh to guide lymph fluid from the outer side of the lower thigh to the inner side of the lower thigh so as to avoid the abnormal lymph vessel group Z1 (see FIGS. 8A to 8C). Furthermore, the second gas chamber of first group F1, G1 applies pressure on the inner side of the lower thigh to guide lymph fluid being guided from the outer side of the lower thigh from the lower thigh to the upper thigh via the normal lymph vessel group Z2 (see FIGS. 8A to 8C). Subsequently, the third gas chamber of second group H1 applies pressure on the backside of the upper thigh to suppress the inflow of lymph fluid into the lymph vessel group Z3, Z4 of the backside of the legs. Next, the first gas chamber of second group I1, J1 applies pressure on the outer side of the upper thigh to guide lymph fluid from the outer side of the upper thigh to the inner side of the upper thigh so as to avoid the abnormal lymph vessel group Z1. Thereafter, the second gas chamber of second group K1, L1 applies pressure on the inner side of the upper thigh to guide lymph fluid being guided from the outer side of the upper thigh and lymph fluid being guided from the lower thigh from the upper thigh to the trunk via the normal lymph vessel group Z2. This further makes it easy for lymph fluid to flow from the lower limbs to the trunk of the human body Z even in a case that the abnormal lymph vessel group Z1 is present, further making it easy to alleviate the symptoms of lymphedema.

Besides, in a case that the gas chambers are divided in the axial direction Q1, the gas supply/discharge system 3 can supply a high-pressure gas in order from the gas chamber to be positioned at a position corresponding to a side being distal from the trunk. In this case, as the gas-type massage device 2 applies pressure on the human body Z such that the gas chamber gradually expands toward the proximal side from the distal side with respect to the trunk of the human body Z, the flow of lymph fluid is further promoted. Specifically, the gas supply/discharge system 3 can supply a high-pressure gas to the first gas chamber of first group D1, E1 in an order of the first distal gas chamber of first group D1 and the first proximal gas chamber of first group E1 (see steps 11 and 12 of FIG. 9(b)) and can supply a high-pressure gas to the second gas chamber of first group F1, G1 in an order of the second distal gas chamber of first group F1 and the second proximal gas chamber of first group G1 (see steps 13 and 14 of FIG. 9(b)). Moreover, the gas supply/discharge system 3 can supply a high-pressure gas to the first gas chamber of second group I1, J1 in an order of the first distal gas chamber of second group I1 and the first proximal gas chamber of second group J1 (see steps 19 and 20 of FIG. 9(b) in particular) and can supply a high-pressure gas to the second gas chamber of second group K1, L1 in an order of the second distal gas chamber of second group K1 and the second proximal gas chamber of second group L1 (see steps 21 and 23 of FIG. 9(b) in particular). Furthermore, in a case that the gas chamber groups A1 to G1 comprise the end gas chamber of first group A1, the gas supply/discharge system 3 can supply a high-pressure gas to the end gas chamber of first group A1 at the beginning of a series of massaging steps (see step 8 in FIG. 9(b)).

In a case that the gas-type massage device 2 comprises the third gas chamber groups M to P, the gas supply/discharge system 3 supplies a high-pressure gas to the first gas chamber groups A1 to G1 and the second gas chamber groups H1 to L1, and then supplies a high-pressure gas to the third gas chamber groups M to P. Note that the gas supply/discharge system 3 can supply a high-pressure gas to a predetermined gas chamber of the first gas chamber groups A1 to G1 and the second gas chamber groups H1 to L1, and then supply a high-pressure gas to a predetermined gas chamber of the third gas chamber groups M to P prior to supplying a high-pressure gas to a gas chamber of the first gas chamber groups A1 to G1 and the second gas chamber groups H1 to L1, to which gas chamber a high-pressure gas has not been supplied. Specifically, the gas supply/discharge system 3 supplies a high-pressure gas to the first gas chamber of third group M to be positioned at the crotch of the human body Z prior to supplying a high-pressure gas to the second gas chamber of second group K1, L1 (more specifically, the second proximal gas chamber of second group L1) to be positioned in the vicinity of the groin of the human body Z of the second gas chamber groups H1 to L1 (see steps 22 and 23 of FIG. 9(b), and FIGS. 11(b) and 11(c)). In this case, as pressure is applied on the crotch prior to pressure being applied on the groin of the human body Z, lymph fluid is prevented from flowing, via the groin from the legs, into the crotch at which lymph fluid tends to build up. More specifically, the gas supply/discharge system 3 supplies a high-pressure gas to the first gas chamber of third group M, the second gas chamber of second group K1, L1 (more specifically, the second proximal gas chamber of second group L1), the second gas chamber of third group N, P (more specifically, the second right gas chamber of third group N) in that order (see steps 22, 23, and 27 of FIG. 9(b), and FIG. 11(c), FIG. 11(d), and FIG. 12(b)). This makes it possible to further promote the flow of lymph fluid to the upper parts of the human body Z while suppressing the inflow of lymph fluid into the crotch of the human body Z. In a case that the third gas chamber groups M to P comprise the third gas chamber of third group O, O, the gas supply/discharge system 3 can supply a high-pressure gas to the second gas chamber of third group N, P (more specifically, the second right gas chamber of third group N) and then in order to the third gas chamber of third group O, O (see steps 27 to 28 of FIG. (b) and FIGS. 12(b) to 12(c)), This makes it possible to promote the flow of lymph fluid to the further upper parts of the human body Z.

In the Specific Example, as shown in FIG. 9(a), as the gas-type massage device 2 is fitted to the human body Z such that the first and second gas-type massage devices 2a, 2b overlap in the axial direction Q1, a part of the second gas chamber groups H1 to L1 comprised in the first gas-type massage device 2a, and a part of the third gas chamber groups M to P comprised in the second gas-type massage device 2b, also overlap in the axial direction Q1 (In FIG. 9(a), the first proximal gas chamber of second group J1 and the second proximal gas chamber of second group L1 (and the third gas chamber of second group H1), and the second right gas chamber of third group N overlap in the axial direction Q1). In this case, even when the gas-type massage device 2 is fitted to the human body Z as two separate members being the first and second gas-type massage devices 2a, 2b, it is made possible to administer a massage to the human body Z (the lower limbs of the human body Z) exhaustively in the axial direction H.

In the middle of the series of massaging steps (steps 8 to 28 in FIG. 9(b)), the gas supply/discharge system 3 can discharge a high-pressure gas from a gas chamber to which a high-pressure gas has been supplied and again supply a high-pressure gas to the above-mentioned gas chamber. Specifically, the gas supply/discharge system 3 can supply a high-pressure gas to a gas chamber (in the Specific Example, the second gas chamber of first group F1, G1 and second gas chamber of second group K1, L1) to be positioned in a region of the human body Z, in an interior of which region the normal lymph vessel groups Z1 to Z4 (in the Specific Example, the lymph vessel group Z2 (see FIGS. 8A to 8C)) are present, and then discharge a high-pressure gas from the above-mentioned gas chamber and again supply a high-pressure gas to the above-mentioned gas chamber (see steps 14 to 17 and steps 23 to 26 of FIG. 9(b)). In light of a series of massaging steps in FIGS. 10 to 12, the gas supply/discharge system 3 can return to the step in FIG. 10(b) after the step in FIG. 10(c), and carry out the step in FIG. 10(c) again, or it can return to the step in FIG. 12(a) after the step in FIG. 12(b), and carry out the step in FIG. 12(b) again. In this way, application of pressure on and release of application of pressure on regions, in the interior of which regions the normal lymph vessel groups Z1 to Z4 (in the Specific Example, the lymph vessel group Z2) are present, are repeated, further making it easy for the lymph fluid to flow toward the trunk from the lower limbs of the human body Z via the above-mentioned lymph vessel groups Z1 to Z4.

As a pre-step prior to the series of massaging steps (steps 8 to 28 in FIG. 9(b)), the gas supply/discharge system 3 can supply a high-pressure gas to at least a part of the gas chambers of the first and second gas chamber groups A1 to L1 and then discharge a high-pressure gas from the gas chamber, to which gas chamber a high-pressure gas has been supplied (see steps 3 to 7 in FIG. 9(b)). In this way, a series of the massaging steps is carried out with the human body Z being relaxed, further making it easy for the lymph fluid to flow toward the trunk of the human body Z. The order of supplying a high-pressure gas to the gas chamber in the pre-step is not particularly limited as long as the human body Z is relaxed. In the Specific Example, prior to the series of the massaging steps, the gas supply/discharge system 3 supplies a high-pressure gas to the first distal gas chamber of first group D1 and the second distal gas chamber of first group F1, the first proximal gas chamber of first group E1 and the second proximal gas chamber of first group G1,the first distal gas chamber of second group I1 and the second distal gas chamber of second group K1, the first proximal gas chamber of second group J1 and the second proximal gas chamber of second group L1 in that order, and thereafter discharges a high-pressure gas from the gas chambers D1 to G1, I1 to L1, to which gas chambers a high-pressure gas has been supplied (see steps 3 to 7 of FIG. 9(b)). In other words, a high-pressure gas is supplied in an order from the gas chamber to be positioned at a position being distal from the trunk of the human body Z and thereafter discharges a high-pressure gas from the gas chamber, to which gas chamber a high-pressure gas has been supplied. Moreover, prior to the series of the massaging steps, for example, the gas supply/discharge system 3 can supply a high-pressure gas to the second distal gas chamber of first group F1, the second proximal gas chamber of first group G1,the second distal gas chamber of second group K1, the second proximal gas chamber of second group L1 in that order, and discharges a high-pressure gas from the gas chamber F1, G1, K1, L1, to which gas chamber F1, G1, K1, L1 a high-pressure gas has been supplied. This allows the inner side of the legs of the human body Z, an interior of which inner side the normal lymph vessel group Z2 (see FIGS. 8A to 8C) is present, through which normal lymph vessel group Z2 at least lymph fluid is to be passed, to relax, further making it easy for lymph fluid to flow toward the trunk from the lower limbs of the human body Z. Moreover, to obtain the same effect, prior to the series of the massaging steps, the gas supply/discharge system 3 can supply a high-pressure gas to the second gas chamber of first group F1, G1, the second gas chamber of second group K1, L1 in that order, or can supply a high-pressure gas to the second gas chamber of first group F1, G1 and the second gas chamber of second group K1, L1 substantially simultaneously.

Prior to the series of the massaging steps (and a pre-step), the gas supply/discharge system 3 can supply, to the first and second gas chamber groups A1 to L1, a pre-loaded gas at the pressure being lower than a set pressure of the high-pressure gas to be supplied in the series of the massaging steps (and the pre-step) (See step 1 in FIG. 9(b). Below, the step to supply a pre-loaded gas is also called “pre-load step”.) In this case, as the first and second gas chamber groups A1 to L1 expand and the first gas-type massage device 2a becomes a size smaller in the internal space thereof, the leg of the human body Z is sandwiched by the expanded first and second gas chamber groups A1 to L1. The sandwiching of the legs of the human body Z by the first and second gas chamber groups A1 to L1 causes the first gas-type massage device 2a to be positioned with respect to the legs of the human body Z such that each of the first and second gas chamber groups A1 to L1 is positioned at a desired position of the legs of the human body Z. Until the gas supply/discharge system 3 starts the series of the massaging steps (or the pre-step), at least a part of the gas chambers of the first and second gas chamber groups A1 to L1 can hold a state in which the pre-loaded gas is supplied (In FIG. 9(b), see steps 1 to 7 for the end gas chamber of first group A1, steps 1 to 8 for the third distal gas chamber of first group B1, steps 1 to 9 for the third proximal gas chamber of first group C1, steps 1 to 17 for the third gas chamber of second group H1, steps 1 to 2 for the first distal gas chamber of first group D1, steps 1 to 3 for the first proximal gas chamber of first group E1, steps 1 to 4 for the first distal gas chamber of second group I1, steps 1 to 5 for the first proximal gas chamber of second group M. In this case, in the series of the massaging steps, the first and second gas chamber groups A1 to L1 further expand by supplying of a high-pressure gas with the first gas-type massage device 2a being positioned and held with respect to the legs of the human body Z as described above, so that a massage is appropriately administered at an intended position of the human body Z. Besides, in a case that the holding of the pre-loaded gas is carried out in at least a part of the first and second gas chamber groups A1 to 11, it is made possible to sufficiently obtain the effect of positioning of the gas-type massage device 2 with respect to the human body Z.

Prior to starting the pre-step, the gas supply/discharge system 3 can once discharge a pre-loaded gas from the first and second gas chamber groups A1 to L1 (See, in FIG. 9(b), step 2 for the second distal gas chamber of first group F1, steps 2 to 3 for the second proximal gas chamber of first group G1, steps 2 to 4 for the second distal gas chamber of second group K1, steps 2 to 5 for the second proximal gas chamber of second group L1). Specifically, a pre-loaded gas is discharged from the gas chambers to be positioned in regions of the human body Z, in an interior of which regions the normal lymph vessel groups Z1 to Z4 (the lymph vessel group Z2 (see FIGS. 8A to 8C) in the Specific Example) are present, through which lymph fluid is to be passed, are (is) present (the second gas chamber of first group F1, G1 and the second gas chamber of second group K1, L1 in the Specific Example). In this case, the difference in application of pressure at the time of transitioning from the pre-load step to the pre-step causes the regions of the human body Z, in the interior of which regions the lymph vessel groups Z1 to Z4, through which lymph fluid is to be passed, are present (the inner side of the legs of the human body Z in the Specific Example) to be relaxed, further making it easy for lymph fluid to flow toward the trunk of the human body Z.

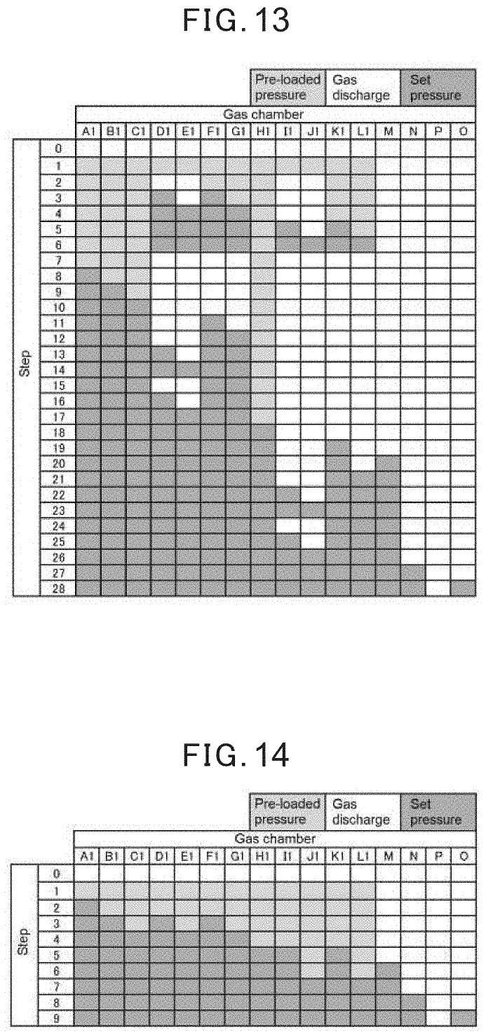

While the massaging steps for a case in which the lymph vessel group Z1 on the outer anterior side of the right leg (see FIGS. 8A to 8C) is abnormal are shown in FIGS. 9 to 12, there is also a case in which the lymph vessel group Z2 on the inner anterior side of the right leg (see FIGS. 8A to 8C) is abnormal. In this case, as shown in Specific Example 2 in FIG. 13 using letters respective for the gas chambers in FIG. 9(a), the gas supply/discharge system 3 supplies a high-pressure gas to the second gas chamber of first group F1, G1 (steps 11 and 12 in FIG. 13), the first gas chamber of first group D1, E1 (steps 13 and 14 in FIG. 13), the second gas chamber of second group K1, L1 (steps 19 and 21 in FIG. 13), the first gas chamber of second group I1, J1 (steps 22 and 23 in FIG. 13) in that order. More specifically, the gas supply/discharge system 3 supplies a high-pressure gas to the third gas chamber of first group B1, C1 (steps 9 and 10 in FIG. 13), the second gas chamber of first group F1, G1 (steps 11 and 12 in FIG. 13), the first gas chamber of first group D1, E1 (steps 13 and 14 in FIG. 13), the third gas chamber of second group H1 (step 18 in FIG. 13), the second gas chamber of second group K1, L1 (steps 19 and 21 in FIG. 13), the first gas chamber of second group I1, J1 (steps 22 and 23 in FIG. 13) in that order. Besides, also in the Specific Example, in the same manner as in Specific Example 1, in a case that the gas-type massage device 2 comprises the third gas chamber groups M to P, to suppress the inflow of lymph fluid into the crotch of the human body Z, a high-pressure gas is supplied to the first gas chamber of third group M (step 20 in FIG. 9(b)) prior to supplying a high-pressure gas (see step 21 in FIG. 13) to the second gas chamber of second group K1, L1 (more specifically, the second proximal gas chamber of second group L1). The other aspects are similar to those in the massaging steps of Specific Example 1 (see FIG. 9(b)), so that detailed explanations thereof will be omitted.

While the massaging steps for a case in which one of the lymph vessel group Z1 on the outer anterior side and the lymph vessel group Z2 on the inner anterior side of the right leg (see FIGS. 8A to 8C) is abnormal are shown in FIGS. 9 to 13, there is also a case in which both thereof are abnormal or a case in which both thereof are normal. In this case, as shown in Specific Example 3 in FIG. 14 using letters respective for the gas chambers in FIG. 9(a), the gas supply/discharge system 3 supplies a high-pressure gas to the first and second distal gas chamber of first group D1, F1 (step 3 in FIG. 14), the first and second proximal gas chamber of first group E1, G1 (step 4 in FIG. 14), the first and second distal gas chamber of second group I1, K1 (step 5 in FIG. 14), the first and second proximal gas chamber of second group I1, J1 (step 7 of FIG. 14) in that order. More specifically, the gas supply/discharge system 3 supplies a high-pressure gas to the first to third distal gas chamber of first group B1, D1, F1 (step 3 in FIG. 14), the first to third proximal gas chamber of first group C1, E1, G1 (step 4 in FIG. 14), the third gas chamber H1 and first and second distal gas chamber I1, K1 of second group (step 5 in FIG. 14), the first and second proximal gas chamber of second group J1, L1 (step 7 in FIG. 14) in that order. Besides, also in the Specific Example, in the same manner as in Specific Example 1, in a case that the gas-type massage device 2 further has the third gas chamber groups M to P, to suppress the inflow of lymph fluid into the crotch of the human body Z, a high-pressure gas is supplied to the first gas chamber of third group M (see step 6 in FIG. 14) prior to supplying a high-pressure gas (see step 7 in FIG. 14; in the Specific Example, as described above, in step 7, a high-pressure gas is also supplied to the first proximal gas chamber of second group J1) to the second gas chamber of second group K1, L1 (more specifically, the second proximal gas chamber of second group L1). The other aspects are similar to those in the massaging steps of Specific Example 1 (see FIG. 9(b) and the like), so that detailed explanations thereof will be omitted here.

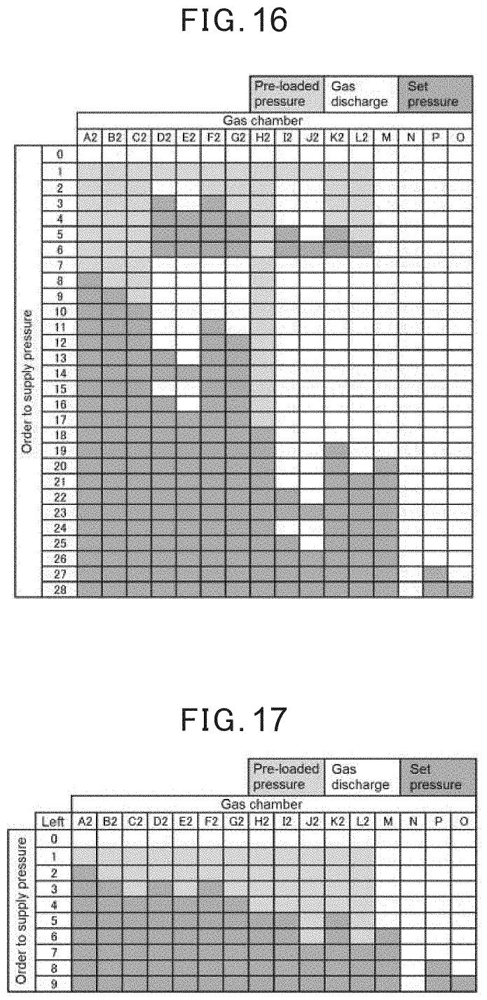

Next, a case in which the first gas-type massage device 2a is fitted to the left leg is explained (Specific Examples 4 to 6). FIGS. 15 to 17 show examples (Specific Examples 4 to 6) in which the first gas-type massage device 2a is fitted to the left leg in the embodiment. FIG. 15(a) shows a position of each of the gas chambers when the first gas-type massage device 2a is fitted to the left leg. FIG. 15(b) shows, in order, Specific Example (Specific Example 4) of massaging steps when the first gas-type massage device 2a is fitted to the left leg, FIG. 16 shows, in order, another Specific Example (Specific Example 5) of massaging steps when the first gas-type massage device 2a is fitted to the left leg, and FIG. 17 shows, in order, yet another Specific Example (Specific Example 6) of massaging steps when the first gas-type massage device 2a is fitted to the left leg. As for lymph vessel groups of the left leg, they are left and right symmetrical with respect to the lymph vessel groups Z1 to Z4 of the right leg, so that the illustrations thereof will be omitted here by referring to FIGS. 8A to 8C regarding the right leg. In addition, the same letters for the lymph vessel groups Z1 to Z4 of the right leg will be used as letters for the lymph vessel groups of the left leg.

As shown in FIGS. 15 to 17, when the first gas-type massage device 2a is fitted to the left leg, a high-pressure gas is supplied in order to first and second gas chamber groups A2 to L2 in accordance with the pathological condition such that the massaging steps is left and right symmetrical with respect to the massaging steps when it is fitted to the right leg. For example, in a case that the lymph vessel group Z1 on an outer anterior side of the left leg (see FIGS. 8A to 8C showing the lymph vessel group Z1 on the outer anterior side of the right leg) is abnormal, as shown in Specific Example 4 in FIG. 15(b) using letters respective for the gas chambers of FIG. 15(a), the gas supply/discharge system 3 supplies a high-pressure gas to the first gas chamber of first group D2, E2 (see steps 11 and 12 of FIG. 15(b)), the second gas chamber of first group F2, G2 (see steps 13 and 14 of FIG. 15(b)), the first gas chamber of second group I2, J2 (see steps 19 and 20 of FIG. 15(b)), the second gas chamber of second group K2, L2 (see steps 21 and 23 of FIG. 15(b)) in that order. For example, in a case that the lymph vessel group Z2 on an inner anterior side of the left leg (see FIGS. 8A to 8C showing the lymph vessel group Z2 on the inner anterior side of the right leg) is abnormal, as shown in Specific Example 5 in FIG. 16 using letters respective for the gas chambers of FIG. 15(a), the gas supply/discharge system 3 supplies a high-pressure gas to the second gas chamber of first group F2, G2 (see steps 11 and 12 of FIG. 16), the first gas chamber of first group D2, E2 (see steps 13 and 14 of FIG.16), the second gas chamber of second group K2, L2 (see steps 19 and 21 of FIG. 16), the first gas chamber of second group I2, J2 (see steps 22 and 23 of FIG. 16) in that order. For example, in a case in which both of the lymph vessel group Z1 on the outer anterior side and the lymph vessel group Z2 on the inner anterior side of the left leg are abnormal or in a case in which both thereof are normal, as shown in Specific Example 6 in FIG. 17 using letters respective for the gas chambers of FIG. 15(a), the gas supply/discharge system 3 supplies a high-pressure gas to the first and second distal gas chamber of first group D2, F2 (see step 3 of FIG. 17), the first and second proximal gas chamber of first group E2, G2 (see step 4 of FIG. 17), the first and second distal gas chamber of second group I2, K2 (see step 5 of FIG. 17), the first and second proximal gas chamber of second group J2, L2 (see step 7 of FIG. 17) in that order.

Also for a case in which the gas-type massage device 2 further has the third gas chamber groups M to P, a high-pressure gas is supplied in order to the first to third gas chamber groups A2 to L2, M to P in accordance with the pathological condition such that the massaging steps is left and right symmetric with respect to the massaging steps when it is fitted to the right leg (see FIG. 16). Also for the other aspects, the massaging steps when the first gas-type massage device 2a is fitted to the left leg is in accordance with the massaging steps when the first gas-type massage device 2a is fitted to the right leg, so that detailed explanations thereof will be omitted.

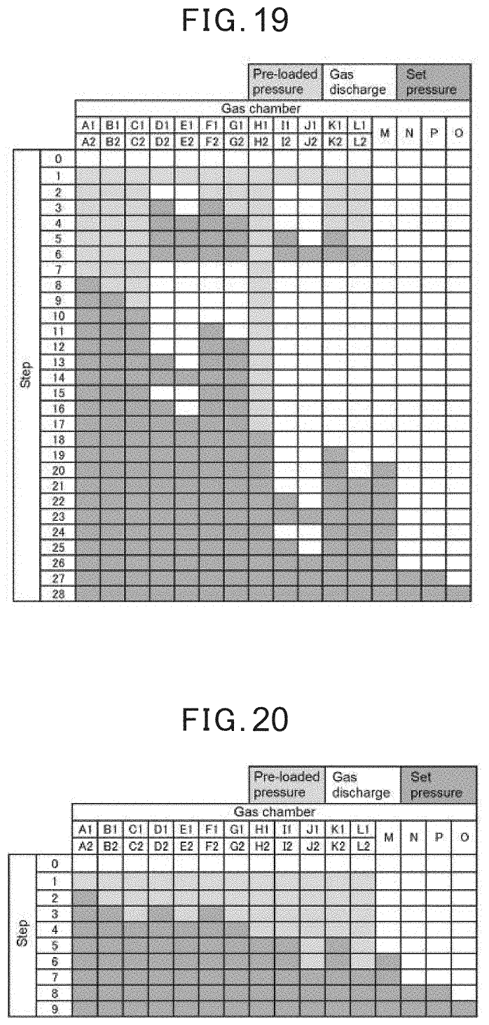

Next, a case in which the first gas-type massage device 2a, 2a is fitted to both of the legs is explained (Specific Examples 7 to 9). FIGS. 18 to 20 show examples (Specific Examples 7 to 9) in which the first gas-type massage device 2a, 2a is fitted to both of the legs in the embodiment. FIG. 18(a) shows a position of each of the gas chambers when the first gas-type massage device 2a, 2a is fitted to both of the legs. FIG. 18(b) shows, in order, Specific Example (Specific Example 7) of massaging steps when the first gas-type massage device 2a, 2a is fitted to both of the legs, FIG. 19 shows, in order, another Specific Example (Specific Example 8) of massaging steps when the first gas-type massage device 2a, 2a is fitted to both of the legs, and FIG. 20 shows, in order, yet another example (Specific Example 9) of massaging steps when the first gas-type massage device 2a, 2a is fitted to both of the legs.

As shown in FIGS. 18 to 20, when the first gas-type massage device 2a, 2a is fitted to both of the legs, a high-pressure gas is supplied in order to the first and second gas chamber groups A1 to L1, A2 to L2 in accordance with the pathological condition with a combination of the massaging steps when it is fitted to the right leg and the left leg. For example, in a case that the lymph vessel group Z1 on the outer anterior side of both of the legs (see FIGS. 8A to 8C showing the lymph vessel group Z1 on the outer anterior side of the right leg) is abnormal, as shown in Specific Example 7 in FIG. 18(b) using letters respective for the gas chambers of FIG. 18(a), the gas supply/discharge system 3 supplies a high-pressure gas to the first gas chamber of first group D1, E1, D2, E2 (see steps 11 and 12 of FIG. 18(b)), the second gas chamber of first group F1, G1,F2, G2 (see steps 13 and 14 of FIG. 18(b)), the first gas chamber of second group I1, J1, 12, J2 (see steps 19 and 20 of FIG. 18(b)), the second gas chamber of second group K1, L1, K2, L2 (see steps 21 and 23 of FIG. 18(b)) in that order. For example, in a case that the lymph vessel group Z2 on the inner anterior side of both of the legs (see FIGS. 8A to 8C showing the lymph vessel group Z2 on the inner anterior side of the right leg) is abnormal, as shown in Specific Example 8 in FIG. 19 using letters respective for the gas chambers of FIG. 18(a), the gas supply/discharge system 3 supplies a high-pressure gas to the second gas chamber of first group F1, G1, F2, G2 (see steps 11 and 12 of FIG. 19), the first gas chamber of first group D1, E1, D2, E2 (see steps 13 and 14 of FIG.19), the second gas chamber of second group K1, L1, K2, L2 (see steps 19 and 21 of FIG. 19), the first gas chamber of second group I1, J1, 12, J2 (see steps 22 and 23 of FIG. 19) in that order. For example, in a case in which both of the lymph vessel group Z1 on the outer anterior side and the lymph vessel group Z2 on the inner anterior side of both of the legs are abnormal, or in a case in which both thereof are normal, as shown in Specific Example 9 in FIG. 20 using letters respective for the gas chambers of FIG. 18(a), the gas supply/discharge system 3 supplies a high-pressure gas to the first and second distal gas chamber of first group D1, F1, D2, F2 (step 3 of FIG. 20), the first and second proximal gas chamber of first group E1, G1,E2, G2 (step 4 of FIG.20), the first and second distal gas chamber of second group I1, K1, 12, K2 (see step 5 of FIG. 20), the first and second proximal gas chamber of second group J1, L1, J2, L2 (step 7 of FIG. 20) in that order.

Also for a case in which the gas-type massage device 2 further has the third gas chamber groups M to P, a high-pressure gas is supplied in order to the first to third gas chamber groups A1 to L1, A2 to L2, M to P in accordance with the pathological condition with a combination of the massaging steps when it is fitted to the right leg and the left leg. Also for the other aspects, the massaging steps when the first gas-type massage device 2a is fitted to the right leg and the left leg is in accordance with the massaging steps when the first gas-type massage device 2a is fitted to the left leg, so that detailed explanations thereof will be omitted here.

Besides, while a case of the lymph vessel groups Z1 to Z4 being abnormal is referred to in the above-mentioned explanation, in a case that the other vessel(s) such as blood vessel(s) is abnormal, the gas-type massage apparatus 1 and the gas-type massage device 2 can be applied to alleviate the above-mentioned pathological condition.

As described above, the gas-type massage device 2 according to the embodiment has a plurality of gas chambers that can receive and discharge a high-pressure gas to expand and contract mutually independently, and the plurality of gas chambers comprise the first and second gas chamber groups 21, 22 (A1 to L1, A2 to L2) to be provided at positions being mutually adjacent in the axial direction Q1. In the embodiment, the first and second gas chamber groups 21, 22 (A1 to L1, A2 to L2) have at least two gas chambers, respectively, along the peripheral direction Q2. Therefore, it is made possible to expand the gas-type massage device 2 only at a position at which pressure is to be applied on the gas-type massage device 2 in the peripheral direction Q2 while avoiding the specific part of the human body Z. Therefore, it is made easy to pass body fluid such as lymph fluid and the like toward the trunk of the human body Z through the vessel groups such as the normal lymph vessel groups Z1 to Z4 and the like of the human body Z.

In the embodiment, the first gas chamber group 21 (A1 to G1,A2 to G2) has the first gas chamber of first group 211 (D1, E1, D2, E2) and the second gas chamber of first group 212 (F1, G1, F2, G2) along the peripheral direction Q2 and, more specifically, further has the third gas chamber of first group 213 (B1, C1, B2, C2) between the first gas chamber of first group 211 (D1, E1, D2, E2) and the second gas chamber of first group 212 (F1, G1, F2, G2) along the peripheral direction Q2. Similarly, the second gas chamber group 22 (H1 to L1, H2 to L2) has the first gas chamber of second group 221 (I1, J1, I2, J2) and the second gas chamber of second group 222 (K1, L1, K2, L2) along the peripheral direction Q2 and, more specifically, further has the third gas chamber of second group 223 (H1, H2) between the first gas chamber of second group 221 (I1 J1, I2, J2) and the second gas chamber of second group 222 (K1, L1, K2, L2) along the peripheral direction Q2. In the embodiment, the first gas chamber of first group 211 (D1, E1, D2, E2) and the first gas chamber of second group 221 (I1 J1, I2, J2) are provided so as to be mutually adjacent in the axial direction Q1, and the second gas chamber of first group 212 (F1, G1,F2, G2) and the second gas chamber of second group 222 (K1, L1, K2, L2) are provided so as to be mutually adjacent in the axial direction Q1. In a case that the first and second gas chamber groups 21, 22 (A1 to L1, A2 to L2) further have the third gas chamber of first group 213 (B1, C1, B2, C2) and the third gas chamber of second group 223 (H1, H2), respectively, the third gas chamber of first group 213 (B1, C1, B2, C2) and the third gas chamber of second group 223 (H1, H2) are provided so as to be mutually adjacent in the axial direction Q1. This makes it easy to position the gas chambers along the vessel groups such as the lymph vessel groups Z1 to Z4, further making it easy to pass body fluid such as lymph fluid and the like toward the trunk of the human body Z.

Moreover, the gas-type massage apparatus 1 according to the embodiment comprises the above-described gas-type massage device 2 and the gas supply/discharge system 3 to supply a high-pressure gas to a plurality of gas chambers and discharge a high-pressure gas from a plurality of gas chambers of the gas-type massage device 2. In the embodiment, the gas supply/discharge system 3 is configured to supply a high-pressure gas to the first gas chamber group 21 (A1 to G1, A2 to G2), and then supply a high-pressure gas to the second gas chamber group 22 (H1 to L1, H2 to L2). In this case, a high-pressure is supplied to the gas chamber to be positioned at a position corresponding to a side being distal and a position corresponding to a side being proximal with respect to the trunk of the human body Z in that order, further making it possible to pass body fluid such as lymph fluid and the like toward the trunk from the end side of the upper limb(s) or the lower limb(s) of the human body Z.

In the embodiment, the gas-type massage device 2 has a shape following at least a part of the legs of the human body Z. In the embodiment, the first gas chamber of first group 211 (D1, E1, D2, E2) is positioned at a position corresponding to the outer side of the lower thigh of the human body Z and the second gas chamber of first group 212 (F1, G1, F2, G2) is positioned at a position corresponding to the inner side of the lower thigh of the human body Z. Moreover, the first gas chamber of second group 221 (II, J1, I2, J2) is positioned at a position corresponding to the outer side of the upper thigh of the human body Z, and the second gas chamber of second group 222 (K1, L1, K2, L2) is positioned at a position corresponding to the inner side of the upper thigh of the human body Z. In a case that the first and second gas chamber groups 21, 22 (A1 to L1, A2 to L2) further have the third gas chamber of first group 213 (B1, C1, B2, C2) and the third gas chamber of second group 223 (H1, H2), respectively, the third gas chamber of first group 213 (B1, C1, B2, C2) is positioned at a position corresponding to the backside of the lower thigh of the human body Z and the third gas chamber of second group 223 (H1, H2) is positioned at a position corresponding to the backside of the upper thigh of the human body Z. In such a case of positioning the gas-type massage device 2 with respect to the human body Z in this way, it is made possible to appropriately pass, toward the trunk, body fluid such as lymph fluid building up in the leg(s) of the human body Z.

In a case that vascular disease (lymphedema and the like) is present in the leg(s) of the human body Z, depending on the pathological condition, even when the vessel group (the lymph vessel group Z1 and the like) on the outer side of the leg(s) is abnormal, the vessel group (the lymph vessel group Z2 and the like) on the inner side of the leg(s) can be normal. In such a case, the gas supply/discharge system 3 supplies a high-pressure gas to the first gas chamber of first group 211 (D1, E1, D2, E2), the second gas chamber of first group 212 (F1, G1, F2, G2), the first gas chamber of second group 221 (IL J1, I2, J2), the second gas chamber of second group 222 (K1, L1, K2, L2) in that order. In such a case of applying pressure on the outer side and then applying pressure on the inner side for each part of the leg(s) of the human body Z in the massaging steps as such, it is made easy to pass body fluid (lymph fluid and the like) toward the trunk via the normal vessel group (the lymph vessel group Z2 and the like) on the inner side of the leg(s) while avoiding the abnormal vessel group (the lymph vessel group Z1 and the like) on the outer side of the leg(s). Therefore, even when the abnormal vessel group (the lymph vessel group Z1 and the like) is present on the outer side of the leg(s), it is made easy to pass body fluid (lymph fluid and the like) toward the trunk from the leg(s), making it easy to alleviate the symptoms of vascular disease (lymphedema and the like).

In a case that the first and second gas chamber groups 21, 22 (A1 to L1, A2 to L2) further have the third gas chamber of first group 213 (B1, C1, B2, C2) and the third gas chamber of second group 223 (H1, H2), respectively, the gas supply/discharge system 3 supplies a high-pressure gas to the third gas chamber of first group 213 (B1, C1, B2, C2), the first gas chamber of first group 211 (D1, E1, D2, E2), the second gas chamber of first group 212 (F1, G1, F2, G2), the third gas chamber of second group 223 (H1, H2), the first gas chamber of second group 221 (IL J1, 12, J2), and the second gas chamber of second group 222 (K1, L1, K2, L2) in that order. In such a case of applying pressure on the backside, the outer side, the inner side in that order for each part of the leg(s) of the human body Z in the massaging steps as such, it is suppressed to flow body fluid (lymph fluid and the like) into the vessel group (the lymph vessel group Z3, Z4, and the like) on the backside of the leg(s), further facilitating passing of body fluid (lymph fluid and the like) from the leg(s) toward the trunk. Therefore, the symptoms of vascular disease (lymphedema and the like) are further alleviated.

Conversely, in a case that vascular disease (lymphedema and the like) is present in the leg(s) of the human body Z, depending on the pathological condition, even when the vessel group (the lymph vessel group Z2 and the like) on the inner side of the leg(s) is abnormal, the vessel group (the lymph vessel group Z1 and the like) on the outer side of the leg(s) can be normal. In such a case, the gas supply/discharge system 3 supplies a high-pressure gas to the second gas chamber of first group 212 (F1, G1, F2, G2), the first gas chamber of first group 211 (D1, E1, D2, E2), the second gas chamber of second group 222 (K1, L1, K2, L2), the first gas chamber of second group 221 (I1 J1, I2, J2) in that order. In such a case of applying pressure on the inner side and then applying pressure on the outer side for each part of the leg(s) of the human body Z in the massaging steps, it is made easy to pass body fluid (lymph fluid and the like) toward the trunk via the normal vessel group (the lymph vessel group Z1 and the like) on the outer side of the leg(s) while avoiding the abnormal lymph vessel group (the lymph vessel group Z2 and the like) on the inner side of the leg(s). Therefore, even when the abnormal lymph vessel group (the lymph vessel group Z2 and the like) is present on the inner side of the leg(s), it is made easy to pass body fluid (lymph fluid and the like) toward the trunk from the leg(s), making it easy to alleviate the symptoms of vascular disease (lymphedema and the like).

In a case that the first and second gas chamber groups 21, 22 (A1 to L1, A2 to L2) further have the third gas chamber of first group 213 (B1, C1, B2, C2) and the third gas chamber of second group 223 (H1, H2), respectively, the gas supply/discharge system 3 supplies a high-pressure gas to the third gas chamber of first group 213 (B1, C1, B2, C2), the second gas chamber of first group 212 (F1, G1, F2, G2), the first gas chamber of first group 211 (D1, E1, D2, E2), the third gas chamber of second group 223 (H1, H2), the second gas chamber of second group 222 (K1, L1, K2, L2), the first gas chamber of second group 221 (I1 J1, I2, J2) in that order. In such a case of applying pressure on the backside, the inner side, the outer side in that order for each part of the leg(s) of the human body Z in the massaging steps as such, the inflow of body fluid (lymph fluid and the like) into the vessel group (the lymph vessel group Z3, Z4, and the like) on the backside of the leg(s) is suppressed, further facilitating passing of body fluid (lymph fluid and the like) from the leg(s) toward the trunk. Therefore, the symptoms of vascular disease (lymphedema and the like) are further alleviated.

[Second Embodiment]

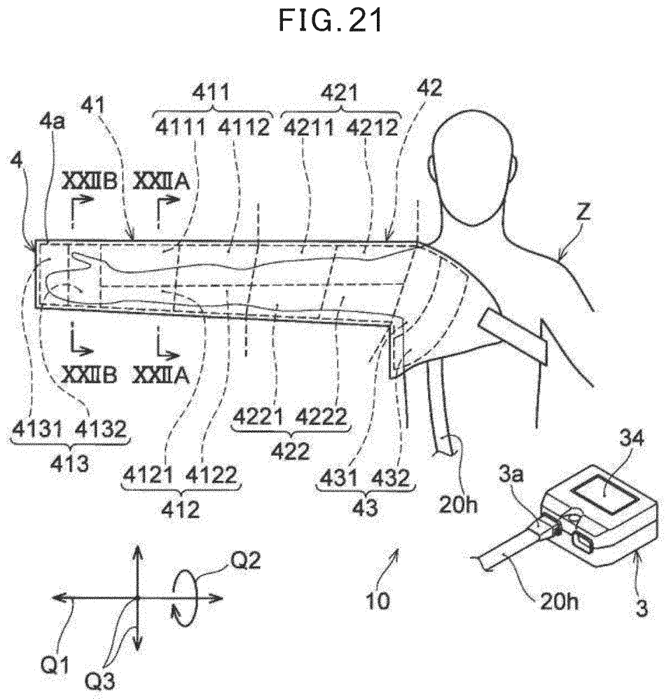

FIG. 21 shows a gas-type massage device 4 and a gas-type massage apparatus 10 according to a second embodiment. The main difference between the second embodiment and the first embodiment is that, while the gas-type massage device 2 has a shape following at least a part of the legs of the human body Z in the first embodiment, the gas-type massage device 4 has a shape following at least a part of arms of the human body Z in the second embodiment. Below, aspects explained in the first embodiment will be omitted, so that explanations will be primarily on the differences. Besides, the embodiment shown below is merely exemplary, so that the gas-type massage apparatus of the invention is not limited to the examples below.

As shown in FIG. 21, in the same manner as in the first embodiment, the gas-type massage apparatus 10 according to the embodiment comprises the gas-type massage device 4 and the gas supply/discharge system 3. Also in the embodiment, in the same manner as in the first embodiment, the gas-type massage device 4 is fluidly connected in a removable manner to the gas supply/discharge system 3 via a hose 20h by means of the connector 3a. Besides, in FIG. 21, for ease of viewing the figures, the human body Z (the arms of the human body Z in FIG. 21) being inserted into the gas-type massage device 4 is drawn with solid lines. Moreover, in the embodiment, the gas supply/discharge system 3 is similar to the gas supply/discharge system 3 used in the first embodiment, so that the same letters are affixed as in the first embodiment.

As shown in FIG. 21, the gas-type massage device 4 according to the embodiment is fitted to the arm of the human body Z along an axial direction Q1 so as to surround the arm of the human body Z in a peripheral direction Q2. As long as the gas-type massage device 4 can be fitted to the arm of the human body Z, the shape thereof is not particularly limited. In the embodiment, the gas-type massage device 4 has an L-letter shape so as to follow the arm of the human body Z. In this way, when the gas-type massage device 4 is fitted to the human body Z to make a bent portion of the L-letter shape follow the shoulder of the human body Z, the gas-type massage device 4 is appropriately positioned at the arm of the human body Z. Note that the gas-type massage device 4 can have a different shape such as a simple cylindrical shape and the like.

As shown in FIG. 21, in the same manner as in the first embodiment, the gas-type massage device 4 has a plurality of gas chambers that can expand and contract mutually independently, and a cover 4a to surround the plurality of gas chambers in the peripheral direction Q2. As the plurality of gas chambers, the gas-type massage device 4 has a first gas chamber group 41 and a second gas chamber group 42. As the plurality of gas chambers, the gas-type massage device 4 can further have a third gas chamber group 43 so as to be mutually adjacent to the second gas chamber group 42 in the axial direction Q1 (on a side being opposite to a side adjacent to the first gas chamber group 41). Besides, in the embodiment, the gas-type massage device 4 does not comprise a fastening device to fasten together the ends of the cover 4a in the peripheral direction Q2 as in the first embodiment, but it can comprise the fastening device.

In the embodiment, as shown in FIG. 21, in the same manner as the first embodiment, the first gas chamber group 41 has at least two gas chambers along the peripheral direction Q2. Specifically, the first gas chamber group 41 has a first gas chamber of first group 411 and a second gas chamber of first group 412 along the peripheral direction Q2. Moreover, in the embodiment, in the same manner as the first embodiment, the second gas chamber group 42 has at least two gas chambers along the peripheral direction Q2. Specifically, the second gas chamber group 42 has a first gas chamber of second group 421 and a second gas chamber of second group 422 along the peripheral direction Q2.

In the embodiment, as shown in FIG. 21, the first gas chamber of first group 411 is divided into a first distal gas chamber of first group 4111 and a first proximal gas chamber of first group 4112 in the axial direction Q1, and the second gas chamber of first group 412 is divided into a second distal gas chamber of first group 4121 and a second proximal gas chamber of first group 4122 in the axial direction Q1. Similarly, in the embodiment, the first gas chamber of second group 421 is divided into a first distal gas chamber of second group 4211 and a first proximal gas chamber of second group 4212 in the axial direction Q1, and the second gas chamber of second group 422 is divided into a second distal gas chamber of second group 4221 and a second proximal gas chamber of second group 4222 in the axial direction Q1. Similarly, in the embodiment, the third gas chamber group 43 is divided into a distal gas chamber of third group 431 and a proximal gas chamber of third group 432 in the axial direction Q1.

As shown in FIG. 21, the first gas chamber group 41 can have an end gas chamber of first group 413 over substantially the entire periphery in the peripheral direction Q2 so as to be adjacent to the first gas chamber of first group 411 and the second gas chamber of first group 412 in the axial direction Q1 (on a side being opposite to a side adjacent to the second gas chamber group 42). In this case, the end gas chamber of first group 413 can be divided into an end distal gas chamber of first group 4131 and an end proximal gas chamber of first group 4132 in the axial direction Q1.

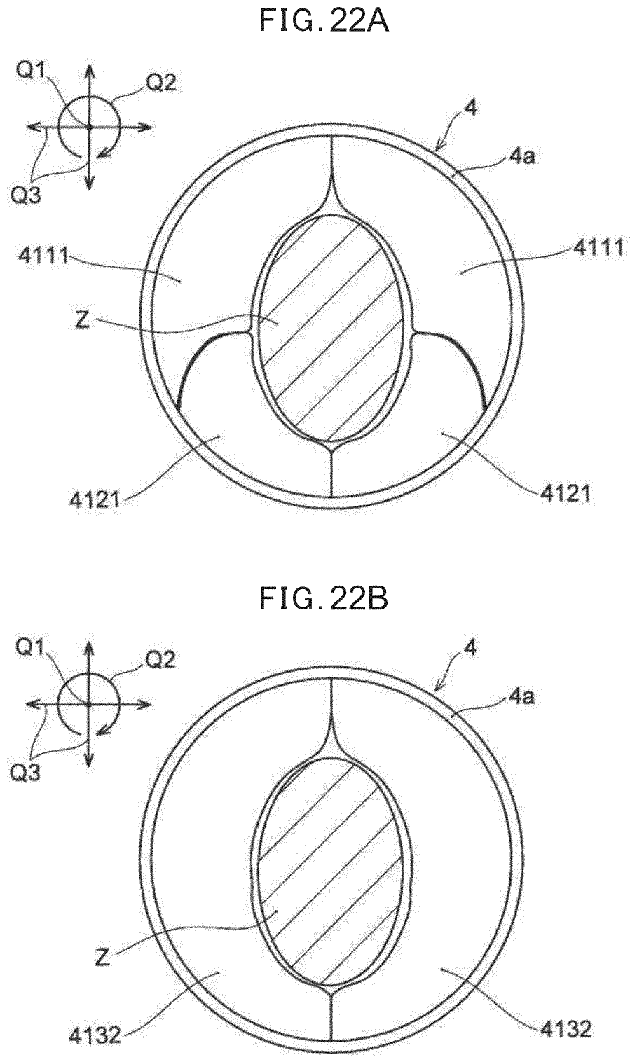

The positional relationship of the gas chambers in the peripheral direction Q2 in each of the first and second gas chambers 41, 42 is not particularly limited. In the embodiment, as shown in FIG. 22A, the gas chambers of the first gas chamber group 41 (In FIG. 22A are shown, as the gas chambers, the first distal gas chamber of first group 4111 and the second distal gas chamber of first group 4121.) have the ends thereof in the peripheral direction Q2 mutually overlapping. In this case, the gas chambers of the first gas chamber group 41 are arranged without gaps in the peripheral direction Q2, so that, when all of the gas chambers of the first gas chamber group 41 expand, pressure can be applied on the human body Z (the arm of the human body Z) exhaustively in the peripheral direction Q2. Moreover, while not particularly shown, in the embodiment, in the same manner as the gas chambers of the first gas chamber group 41, the gas chambers of the second gas chamber group 42 have the ends thereof in the peripheral direction Q2 mutually overlapping. Note that, in each of the first and second gas chamber groups 41, 42, the gas chambers do not have to overlap mutually, so that they can be provided so as to be in mutual separation.

In the embodiment, as shown in FIGS. 22A and 22B, the gas chambers of the first gas chamber group 41 are divided in the peripheral direction Q2 so as to be line symmetrical with one direction (up-down direction shown in FIGS.) of the radial directions Q3 as the axis (In FIG. 22A are shown, as the gas chambers, the first distal gas chamber of first group 4111 and the second distal gas chamber of first group 4121 and in FIG. 22B is shown, as the gas chamber, the end proximal gas chamber of first group 4132.) Similarly, while not particularly shown, the gas chambers of the second gas chamber group 42 are divided in the peripheral direction Q2 so as to be line symmetrical with one direction (up-down direction shown in FIGS.) of the radial directions Q3 as the axis. In this way, when the flat hands of the human body Z being inserted into the gas-type massage device 4 along the cracks of the divided gas chambers, it is made easy to fit the gas-type massage device 4 to the arm of the human body Z. The divided gas chambers of the first and second gas chamber groups 41, 42 can be independently expandable and contractible or can be integrally expandable and contractible. Note that the gas chambers of the first and second gas chamber groups 41, 42 do not necessarily have to be divided, respectively.

In the embodiment, when the gas-type massage device 4 is fitted to the upper limb (the one arm) of the human body Z, the first gas chamber of first group 411 is positioned at a position corresponding to an anterior side of a forearm (a radial forearm (the upper side in FIG. 21); below, similarly expressed when referring to the orientation with respect to the upper limb.) of the human body Z, and the second gas chamber of first group 412 is positioned at a position corresponding to a posterior side of the forearm (an ulnar forearm (the lower side in FIG. 21); below, similarly expressed when referring to the orientation with respect to the upper limb.) of the human body Z Moreover, in the embodiment, when the gas-type massage device 4 is fitted to the upper limb (the one arm) of the human body Z, the first gas chamber of second group 421 is positioned at a position corresponding to an anterior side of a upper arm (a radial upper arm) of the human body Z, and the second gas chamber of second group 422 is positioned at a position corresponding to a posterior side of the upper arm (a ulnar upper arm) of the human body Z. In this case, the end gas chamber of first group 413 is positioned at a position corresponding to the hand of the human body Z and the third gas chamber group 43 is positioned at a position corresponding to the shoulder of the human body Z.

Next, an example of massaging steps by the gas-type massage apparatus 10 according to the embodiment is described. Besides, the explanations below are merely exemplary, so that the massaging steps by means of the gas-type massage apparatus of the invention is not limited to the examples below.

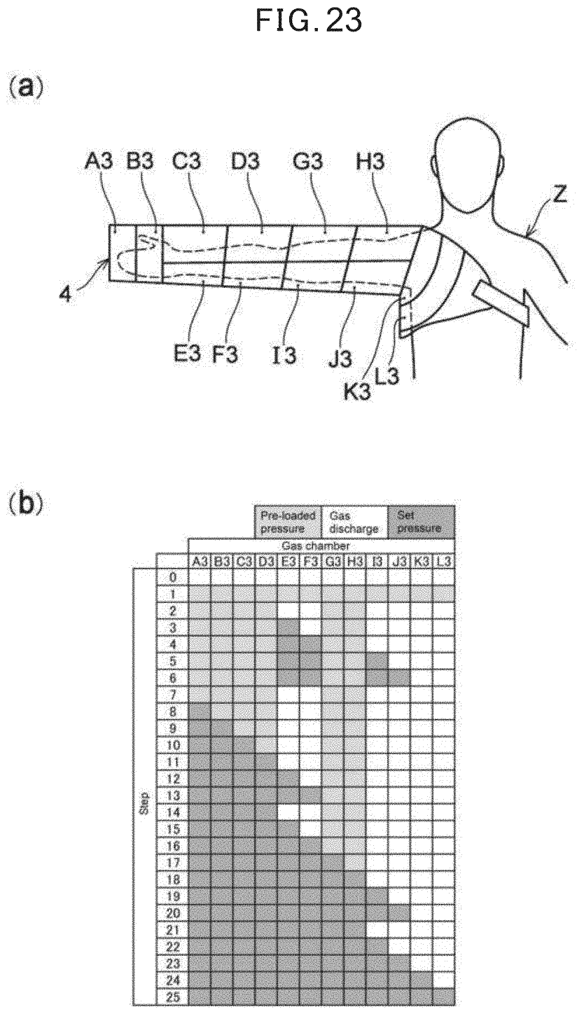

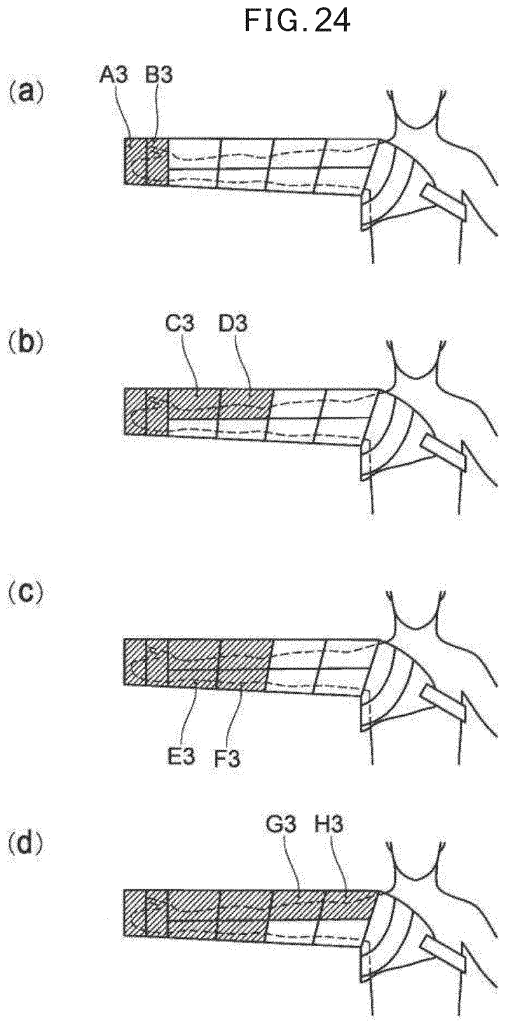

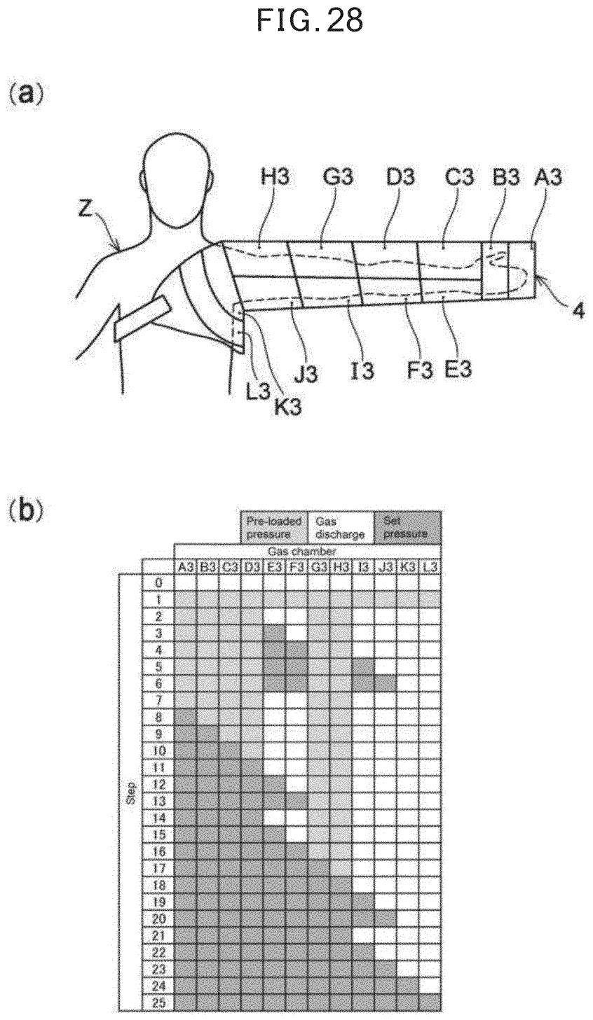

In the explanations below, for convenience of explanations, letters for the gas chambers comprised in the first gas chamber group 41, “4131, 4132, 4111, 4112, 4121, 4122” (see FIG. 21), are replaced by “A3, B3, C3, D3, E3, F3” (see FIG. 23(a) and FIG. 28(a)), respectively. Moreover, letters for the gas chambers comprised in the second gas chamber group 42, “4211, 4212, 4221, 4222” (see FIG. 21), are replaced by “G3, H3, I3, J3” (see FIG. 23(a) and FIG. 28(a)), respectively. Furthermore, letters for the gas chambers of the third gas chamber group 43, “431, 432” (see FIG. 21), are replaced by “K3, L3” (see FIG. 23(a) and FIG. 28(a)), respectively. Besides, in FIG. 23(a), FIGS. 24 to 25, FIG. 28, for ease of viewing the figures, the cover 4a of the gas-type massage device 4 is not shown.

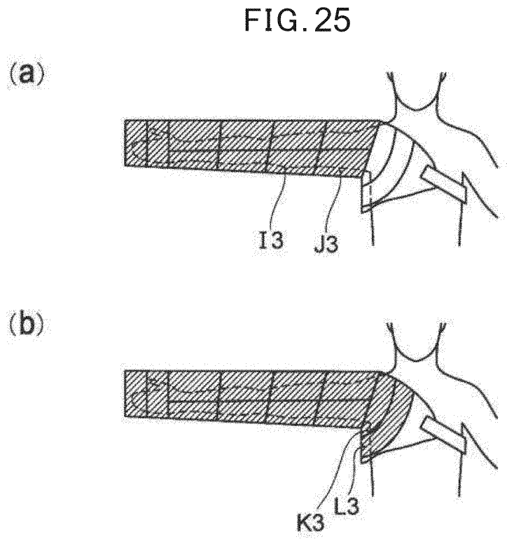

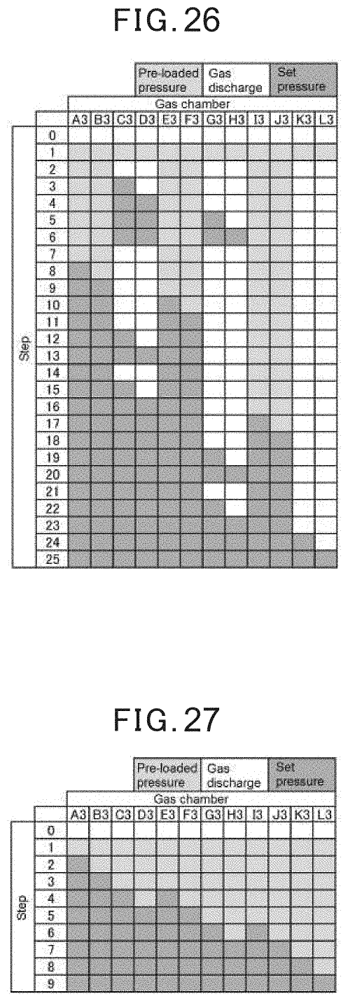

First, a case in which the gas-type massage device 4 is fitted to the right arm is explained (Specific Examples 10 to 12). FIGS. 23 to 27 show examples (Specific Examples 10 to 12) in which the gas-type massage device 4 is fitted to the right arm in the embodiment. FIG. 23(a) shows a position of each of the gas chambers when the gas-type massage device 4 is fitted to the right arm. FIG. 23(b) shows, in order, Specific Example (Specific Example 10) of massaging steps when the gas-type massage device 4 is fitted to the right arm, and FIGS. 24 to 25 show, in order, main steps of the massaging steps in FIG. 23(b). FIG. 26 shows, in order, another Specific Example (Specific Example 11) of massaging steps when the gas-type massage device 4 is fitted to the right arm, and FIG. 27 shows, in order, yet another Specific Example (Specific Example 12) of massaging steps when the gas-type massage device 4 is fitted to the right arm.

In the embodiment, it is intended that lymph fluid be passed to the trunk from the upper limb of the human body Z to alleviate the symptoms of lymphedema of the upper limb of the human body Z using the gas-type massage device 10. While not shown, the lymph vessel groups in the upper limb of the human body Z are divided into the lymph vessel group on the anterior side of the arm and the lymph vessel group on the posterior side of the arm. In a case of lymphedema of the upper limb, in an initial condition of the disease, either one of the lymph vessel group on the anterior side and the lymph vessel group on the posterior side of the arm being abnormal is often seen. In this case, even when pressure is simply applied on regions of the human body Z, in an interior of which regions the abnormal lymph vessel groups are present, it is difficult for lymph fluid to flow toward the trunk from the above-mentioned lymph vessel groups.

For example, in a case that the lymph vessel group on an anterior side of the right arm is abnormal, as shown in Specific Example 10 in FIG. 23(b) and FIGS. 24 to 25 using letters respective for the gas chambers of FIG. 23(a), the gas supply/discharge system 3 supplies a high-pressure gas to the first gas chamber of first group C3, D3 (see steps 10 and 11 of FIG. 23(b), and FIG. 24(c)), the second gas chamber of first group E3, F3 (see steps 12 and 13 of FIG. 23(b), and

FIG. 24(c)), the first gas chamber of second group G3, H3 (see steps 17 and 18 of FIG. 23(b), and FIG. 24(d)), and the second gas chamber of second group I3, J3 (see steps 19 and 20 of FIG. 23(b), and FIG. 25(a)) in that order. Then, first, the first gas chamber of first group C3, D3 applies pressure on the anterior side of the forearm to guide lymph fluid from the anterior side of the forearm to the posterior side of the forearm so as to avoid the abnormal lymph vessel group on the anterior side of the arm. Thereafter, the second gas chamber of first group E3, F3 applies pressure on the posterior side of the forearm to guide lymph fluid being guided from the anterior side of the forearm from the forearm to the upper arm via the normal lymph vessel group on the posterior side of the arm. Subsequently, the first gas chamber of second group G3, H3 applies pressure on the anterior side of the upper thigh to guide lymph fluid from the anterior side of the upper thigh to the posterior side of the upper thigh so as to avoid the abnormal lymph vessel group on the anterior side of the arm. Thereafter, the second gas chamber of second group I3, J3 applies pressure on the posterior side of the upper arm to guide lymph fluid being guided from the anterior side of the upper arm and lymph fluid being guided from the forearm from the upper arm to the trunk via the normal lymph vessel group on the posterior side of the arm. This makes it easy for lymph fluid to flow from the upper limb toward the trunk even in a case that the abnormal lymph vessel group is present, making it easy to alleviate the symptoms of lymphedema.

In a case that the gas-type massage device 4 comprises the end gas chamber of first group A3, B3, the gas supply/discharge system 3 supplies a high-pressure gas to the end gas chamber of first group A3, B3 at the beginning of a series of the massaging steps (see steps 8 and 9 in FIG. 23(b), and FIG. 24(a)). This facilitates the flow toward the trunk of lymph fluid at the end of the arm of the human body Z. Moreover, in a case that the gas-type massage device 4 comprises the third gas chamber group K3, L3, the gas supply/discharge system 3 supplies a high-pressure gas to the second gas chamber of second group I3, J3 and then supplies a high-pressure gas to the third gas chamber group K3, L3 (see steps 24 and 25 in FIG. 23(b), and FIG. 25(b)). This further facilitates the flow of lymph fluid from the upper limb toward the trunk.

Besides, in a case that each of the gas chambers is divided in the axial direction Q1, the gas supply/discharge system 3 can supply a high-pressure gas in order from the gas chamber to be positioned at a position corresponding to a side being distal from the trunk. Specifically, the gas supply/discharge system 3 can supply a high-pressure gas to the first gas chamber of first group C3, D3 in an order of the first distal gas chamber of first group C3 and the first proximal gas chamber of first group D3 (Steps 10 and 11 of FIG. 23(b)), can supply a high-pressure gas to the second gas chamber of first group E3, F3 in an order of the second distal gas chamber of first group E3 and the second proximal gas chamber of first group F3 (Steps 12 and 13 of FIG. 23(b)), and can supply a high-pressure gas to the end gas chamber of first group A3, B3 in an order of the end distal gas chamber of first group A3 and the end proximal gas chamber of first group B3 (Steps 8 and 9 of FIG. 23(b)). Moreover, the gas supply/discharge system 3 can supply a high-pressure gas to the first gas chamber of second group G3, H3 in an order of the first distal gas chamber of second group G3 and the first proximal gas chamber of second group H3 (Steps 17 and 18 of FIG. 23(b)) and can supply a high-pressure gas to the second gas chamber of second group I3, J3 in an order of the second distal gas chamber of second group I3 and the second proximal gas chamber of second group J3 (Steps 19 and 20 of FIG. 23(b)). Furthermore, the gas supply/discharge system 3 can supply a high-pressure gas to the third gas chamber group K3, L3 in an order of the distal gas chamber of third group K3 and the proximal gas chamber of third group L3 (Steps 24 and 25 of FIG. 23(b)).

In the same manner as the first embodiment, in the middle of the series of the massaging steps, the gas supply/discharge system 3 can discharge a high-pressure gas from a gas chamber into which a high-pressure gas has been supplied and again supply a high-pressure gas to the above-mentioned gas chamber. Specifically, the gas supply/discharge system 3 can supply a high-pressure gas to a gas chamber (in the Specific Example, the second gas chamber of first group E3, F3 and second gas chamber of second group I3, J3) to be positioned in a region, in an interior of which region the normal lymph vessel group (in the Specific Example, the lymph vessel group on the posterior side of the right arm) is present, and then discharge a high-pressure gas from the above-mentioned gas chamber and again supply a high-pressure gas to the above-mentioned gas chamber (see steps 12 to 16 and 19 to 23 of FIG. 23(b)). In light of the series of the massaging steps in FIGS. 24 to 25, the gas supply/discharge system 3 can return to the step in FIG. 24(b) after the step in FIG. 24(c), and then carry out the step in FIG. 24(c) again, or it can return to the step in FIG. 24(d) after the step in FIG. 25(a), and then carry out the step in FIG. 25(a) again. In this way, application of pressure on and release of application of pressure on a region, in the interior of which region the normal lymph vessel group (in Specific Example, the lymph vessel group on the posterior side of the right arm) is present, are repeated, further facilitating the flow of lymph fluid toward the trunk from the upper limb of the human body Z via the above-mentioned lymph vessel group.

In the same manner as the first embodiment, as a pre-step prior to a series of the massaging steps (Steps 8 to 25 in FIG. 23(b)) to relax the human body Z, the gas supply/discharge system 3 can supply a high-pressure gas to at least a part of the gas chambers of the first and second gas chamber groups A3 to J3 and then discharge a high-pressure gas from the gas chamber to which a high-pressure gas has been supplied (see steps 3 to 7 in FIG. 23(b)). In the Specific Example, prior to the series of the massaging steps, the gas supply/discharge system 3 supplies a high-pressure gas to the second distal gas chamber of first group E3, the second proximal gas chamber of first group F3, the second distal gas chamber of second group I3, the second proximal gas chamber of second group J3 in that order, and thereafter discharges a high-pressure gas from the gas chambers E3, F3, I3, J3, to which gas chambers a high-pressure gas has been supplied (see steps 3 to 7 in FIG. 23(b)). In other words, in the pre-step, a high-pressure gas is supplied to the gas chambers in order from a side being distal when viewed from the trunk of the human body Z, which gas chambers are to be positioned at positions corresponding to the parts on the posterior side of the arm of the human body Z, in an interior of which parts the normal lymph vessel group is present, through which lymph fluid is to be passed. This causes the posterior side of the arm of the human body Z to be relaxed, further facilitating the flow of lymph fluid via the normal lymph vessel group. Similarly, to relax the posterior side of the arm of the human body Z, prior to the series of the massaging steps, the gas supply/discharge system 3 can supply a high-pressure gas to the second distal gas chamber of first group E3 and the second proximal gas chamber of first group F3, the second distal gas chamber of second group I3 and the second proximal gas chamber of second group J3 in that order, and thereafter discharge a high-pressure gas from the gas chambers E3, F3, I3, J3, to which gas chambers a high-pressure gas has been supplied, or can supply a high-pressure gas to the second distal gas chamber of first group E3, the second proximal gas chamber of first group F3, the second distal gas chamber of second group I3, and the second proximal gas chamber of second group J3 substantially simultaneously, and thereafter discharge a high-pressure gas from the gas chambers E3, F3, I3, J3, to which gas chambers a high-pressure gas has been supplied. Moreover, in the same manner as in the first embodiment, for example, prior to the series of the massaging steps, the gas supply/discharge system 3 can supply a high-pressure gas to the first distal gas chamber of first group C3 and the second distal gas chamber of first group E3, the first proximal gas chamber of first group D3 and the second proximal gas chamber of first group F3, the first distal gas chamber of second group G3 and the second distal gas chamber of second group I3, the first proximal gas chamber of second group H3, the second proximal gas chamber of second group J3 in that order, and thereafter discharge a high-pressure gas from the gas chambers C3 to J3, to which gas chambers C3 to J3 a high-pressure gas has been supplied.

To position the gas-type massage device 4 with respect to the arm of the human body Z by sandwiching of the arm of the human body Z due to expansion of the gas chambers, prior to the series of the massaging steps (and a pre-step), in the same manner as the first embodiment, the gas supply/discharge system 3 can supply a pre-loaded gas to the first and second gas chamber groups A3 to J3 (see step 1 in FIG. 23(b)). Moreover, to hold the positioning of the gas-type massage device 4 with respect to the arm, in the same manner as in the first embodiment, until the gas supply/discharge system 3 starts the series of the massaging steps (or the pre-step), in at least a part of the gas chambers of the first and second gas chamber groups A3 to J3, it can hold a state in which the pre-loaded gas is supplied (In FIG. 23(b), see steps 1 to 7 for the end distal gas chamber of first group A3, steps 1 to 8 for the end proximal gas chamber of first group B3, steps 1 to 9 for the first distal gas chamber of first group C3, steps 1 to 10 for the first proximal gas chamber of first group D3, steps 1 to 16 for the first distal gas chamber of second group G3, steps 1 to 17 for the first proximal gas chamber of second group H3). Moreover, in the same manner as in the first embodiment, to relax the vicinity of the lymph vessel group, through which lymph vessel group lymph fluid is to be passed, prior to starting the pre-step, the gas supply/discharge system 3 can once discharge a pre-loaded gas from the first and second gas chamber groups A3 to J3 (In FIG. 23(b), see step 2 for the second distal gas chamber of first group E3, steps 2 and 3 for the second proximal gas chamber of first group F3, steps 2 to 4 for the second distal gas chamber of second group I3, steps 2 to 5 for the second proximal gas chamber of second group J3).

While FIGS. 23 to 25 show the massaging steps for a case in which the lymph vessel group on the anterior side of the right arm is abnormal, the lymph vessel group on the posterior side of the right arm can also be abnormal. In this case, as shown in Specific Example 11 in FIG. 26 using letters respective for the gas chambers in FIG. 23(a), the gas supply/discharge system 3 supplies a high-pressure gas to the second gas chamber of first group E3, F3 (Steps 10 and 11 in FIG. 26), the first gas chamber of first group C3, D3 (Steps 12 and 13 in FIG. 26), the second gas chamber of second group I3, J3 (Steps 17 and 18 in FIG. 26), the first gas chamber of second group G3, H3 (Steps 19 and 20 in FIG. 26) in that order. In a case that the gas-type massage device 4 comprises the third gas chamber group K3, L3, the gas supply/discharge system 3 supplies a high-pressure gas to the first gas chamber of second group G3, H3, and then supplies a high-pressure gas to the third gas chamber group K3, L3 (Steps 24 and 25 in FIG. 26). The other aspects are in accordance with the massaging steps (see FIG. 23(b) and the like) of Specific Example 10, so that detailed explanations will be omitted.

While FIGS. 23 to 26 show the massaging steps for the cases in which either one of the lymph vessel group on the anterior side and the lymph vessel group on the posterior side of the right arm is abnormal, there can be a case in which both thereof are abnormal or both thereof are normal. In this case, as shown in Specific Example 12 in FIG. 27 using letters respective for the gas chambers in FIG. 23(a), the gas supply/discharge system 3 supplies a high-pressure gas to the first and second distal gas chamber of first group C3, E3 (Step 4 of FIG. 27), the first and second proximal gas chamber of first group D3, F3 (Step 5 of FIG. 27), the first and second distal gas chamber of second group G3, 13 (Step 6 of FIG. 27), the first and second proximal gas chamber of second group H3, J3 (Step 7 of FIG. 27) in that order. In a case that the gas-type massage device 4 comprises the third gas chamber group K3, L3, the gas supply/discharge system 3 supplies a high-pressure gas to the third gas chamber group K3, L3 after supplying a high-pressure gas to the first and second proximal gas chamber of second group H3, J3 (Steps 8 and 9 in FIG. 27). Moreover, the gas supply/discharge system 3 can supply a pre-loaded gas to the first and second gas chamber groups A3 to J3 prior to the series of the massaging steps, and, in a case that the gas-type massage device 4 comprises the third gas chamber group K3, L3, the gas supply/discharge system 3 can also supply a pre-loaded gas to the third gas chamber group K3, L3 prior to the series of the massaging steps. Moreover, in a case that the pre-loaded gas is supplied to the first and second gas chamber groups A3 to J3 (and the third gas chamber group K3, L3), until the series of the massaging steps is started, the gas supply/discharge system 3 can hold the state in which the pre-loaded gas is supplied.

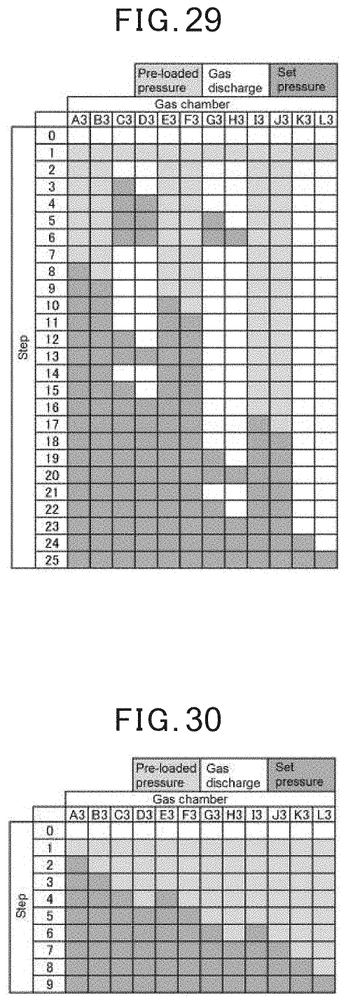

Next, a case in which the gas-type massage device 4 is fitted to the left arm is explained (Specific Examples 13 to 15). In the embodiment, FIGS. 28 to 30 show examples (Specific Examples 13 to 15) in which the gas-type massage device 4 is fitted to the left arm. FIG. 28(a) shows a position of each of the gas chambers when the gas-type massage device 4 is fitted to the left arm. FIG. 28(b) shows, in order, a Specific Example (Specific Example 13) of massaging steps when the gas-type massage device 4 is fitted to the left arm, FIG. 29 shows, in order, another Specific Example (Specific Example 14) of massaging steps when the gas-type massage device 4 is fitted to the left arm, and FIG. 30 shows, in order, yet another Specific Example (Specific Example 15) of massaging steps when the gas-type massage device 4 is fitted to the left arm.

As shown in FIGS. 28 to 30, when the gas-type massage device 4 is fitted to the left arm, the gas supply/discharge system 3 supplies a high-pressure gas in order to the first and second gas chamber groups A3 to J3 in accordance with the pathological condition such that the massaging steps is left and right symmetrical with respect to the massaging steps when it is fitted to the right arm. For example, in a case that the lymph vessel group on the anterior side of the left arm is abnormal, as shown in Specific Example 13 in FIG. 28(b) using letters respective for the gas chambers of FIG. 28(a), the gas supply/discharge system 3 supplies a high-pressure gas to the first gas chamber of first group C3, D3 (see steps 10 and 11 of FIG. 28(b)), the second gas chamber of first group E3, F3 (see steps 12 and 13 of FIG. 28(b)), the first gas chamber of second group G3, H3 (see steps 17 and 18 of FIG. 28(b)), and the second gas chamber of second group I3, J3 (see steps 19 and 20 of FIG. 28(b)) in that order. For example, in a case that the lymph vessel group on the posterior side of the left arm is abnormal, as shown in Specific Example 14 in FIG. 29 using letters respective for the gas chambers of FIG. 28(a), the gas supply/discharge system 3 supplies a high-pressure gas to the second gas chamber of first group E3, F3 (see steps 10 and 11 of FIG. 29), the first gas chamber of first group C3, D3 (see steps 12 and 13 of FIG. 29), the second gas chamber of second group I3, J3 (see steps 17 and 18 of FIG. 29), and the first gas chamber of second group G3, H3 (see steps 19 and 20 of FIG. 29) in that order. For example, in a case in which both of the lymph vessel group on the anterior side and the lymph vessel group on the posterior side of the left arm are abnormal or in a case in which both thereof are normal, as shown in Specific Example 15 in FIG. 30 using letters respective for the gas chambers of FIG. 28(a), the gas supply/discharge system 3 supplies a high-pressure gas is supplied to the first and second distal gas chamber of first group C3, E3 (Step 4 in FIG. 30), the first and second proximal gas chamber of first group D3, F3 (Step 5 in FIG. 30), the first and second distal gas chamber of second group G3, I3 (Step 6 in FIG. 30), and the first and second proximal gas chamber of second group H3, J3 (Step 7 in FIG. 30) in that order. Also for a case in which the gas-type massage device 4 further has the third gas chamber group K3, L3, the gas supply/discharge system 3 supplies a high-pressure gas in order to the first to third gas chamber groups A3 to L3 in accordance with the pathological condition such that the massaging steps is left and right symmetrical with respect to the massaging steps when it is fitted to the right arm. The other aspects are also in accordance with the massaging steps when the gas-type massage device 4 is fitted to the right arm, so that detailed explanations will be omitted here.

Besides, in FIGS. 23 to 30, the gas-type massage device 4 is fitted to the right arm or the left arm to administer a massage to the human body Z, but, with two of the gas-type massage devices 4 being provided, the gas-type massage device 4, 4 can be fitted to the right arm and the left arm, respectively, to administer a massage to the human body Z. While not particularly shown in this case, massaging steps when the gas-type massaging device 4 is fitted to the right arm and the left arm can be combined to supply in order a high-pressure gas to the first and second gas chamber groups A3 to L3, A3 to L3 of each of the two gas-type massage device 4, 4 in accordance with the pathological condition.

As described above, the gas-type massage device 4 according to the embodiment has a shape following at least a part of the arms of the human body Z. In the embodiment, the first gas chamber of first group 411 (C3, D3) is positioned at a position corresponding to the anterior side of the forearm of the human body Z, the second gas chamber of first group 412 (E3, F3) is positioned at a position corresponding to the posterior side of the forearm of the human body Z, the first gas chamber of second group 421 (G3, H3) is positioned at a position corresponding to the anterior side of the upper arm of the human body Z, the second gas chamber of second group 422 (13, J3) is positioned at a position corresponding to the posterior side of the upper arm of the human body Z. In such a case of positioning the gas-type massaging device 4 with respect to the human body Z in this way, it is made possible to appropriately pass, toward the trunk, body fluid such as lymph fluid and the like, which lymph fluid builds up in the arm(s) of the human body Z.

In a case that vascular disease (lymphedema and the like) is present in the arm(s) of the human body Z, depending on the pathological condition, even when the vessel group (the lymph vessel group and the like) on the anterior side of the arm(s) is abnormal, the vessel group (the lymph vessel group and the like) on the posterior side of the arm(s) can be normal. In such a case, in the same manner as in Specific Example 1 and the like of the first embodiment, the gas supply/discharge system 3 supplies a high-pressure gas to the first gas chamber of first group 411 (C3, D3), the second gas chamber of first group 412 (E3, F3), the first gas chamber of second group 421 (G3, H3), the second gas chamber of second group 422 (I3, J3) in that order. In such a case of applying pressure on the anterior side and then applying pressure on the posterior side for each part of the arm(s) of the human body Z in the massaging steps as such, it is made easy to pass body fluid (lymph fluid and the like) toward the trunk via the normal vessel group (the lymph vessel group and the like) on the posterior side of the arm(s) while avoiding the abnormal vessel group (the lymph vessel group) on the anterior side of the arm(s). Therefore, even when the abnormal vessel group (the lymph vessel group and the like) is present on the anterior side of the arm(s), it is made easy to pass body fluid (lymph fluid and the like) toward the trunk from the arm(s), making it easy to alleviate the symptoms of vascular disease (lymphedema and the like).

Conversely, depending on the pathological condition, even when the vessel group (the lymph vessel group and the like) on the posterior side of the arm(s) is abnormal, the vessel group (the lymph vessel group and the like) on the anterior side of the arm(s) can be normal. In such a case, in the same manner as in Specific Example 2 and the like of the first embodiment, the gas supply/discharge system 3 supplies a high-pressure gas to the second gas chamber of first group 412 (E3, F3), the first gas chamber of first group 411 (C3, D3), the second gas chamber of second group 422 (I3, J3), the first gas chamber of second group 421 (G3, H3) in that order. In such a case of applying pressure on the posterior side and then applying pressure on the anterior side for each part of the arm(s) of the human body Z in the massaging steps as such, it is made easy to pass body fluid (lymph fluid and the like) toward the trunk via the normal vessel group (the lymph vessel group and the like) on the anterior side of the arm(s) while avoiding the abnormal vessel group (the lymph vessel group) on the posterior side of the arm(s). Therefore, even when the abnormal vessel group (the lymph vessel group and the like) is present on the posterior side of the arm(s), it is made easy to pass body fluid (lymph fluid and the like) toward the trunk from the arm(s), making it easy to alleviate the symptoms of vascular disease (lymphedema and the like).

Besides, in the above-described embodiments, the gas-type massage device 2, 4 is fitted to either one of the upper limb(s) and the lower limb(s) of the human body Z to administer a massage to either one of the upper limb(s) and the lower limb(s). However, the gas-type massage device 2, 4 can be fitted to the upper limb(s) and the lower limb(s), respectively, of the human body Z to administer a massage to both of the upper limb(s) and the lower limb(s) simultaneously.

The gas-type massage devices and the gas-type massage apparatuses according to representative embodiments of the invention are shown below, but the representative embodiments below are merely exemplary, so that the gas-type massage devices and the gas-type massage apparatuses of the invention are not limited to the examples below.

A gas-type massage device according to one embodiment of the invention is a gas-type massage device to be fitted to at least one part of upper limbs or lower limbs of a human body along an axial direction in which the one part extends so as to surround the one part in a peripheral direction to administer a massage to the human body using a high-pressure gas, wherein the gas-type massage device has a plurality of gas chambers, each of which plurality of gas chambers can receive and discharge a high-pressure gas to expand and contract mutually independently, the plurality of gas chambers comprise a first gas chamber group and a second gas chamber group being provided so as to be mutually adjacent in the axial direction, and each of the first gas chamber group and the second gas chamber group has at least two gas chambers along the peripheral direction.

The first gas chamber group can have a first gas chamber of first group and a second gas chamber of first group along the peripheral direction, the second gas chamber group can have a first gas chamber of second group and a second gas chamber of second group along the peripheral direction, the first gas chamber of first group and the first gas chamber of second group can be provided so as to be mutually adjacent in the axial direction, and the second gas chamber of first group and the second gas chamber of second group can be provided so as to be mutually adjacent in the axial direction.

The gas-type massage device can have a shape following at least a part of legs of the human body, and the gas-type massage device can be configured such that, when the gas-type massage device is fitted to the legs of the human body, a first gas chamber of first group is positioned at a position corresponding to an outer side of the lower thigh of the human body, a second gas chamber of first group is positioned at a position corresponding to an inner side of the lower thigh of the human body, a first gas chamber of second group is positioned at a position corresponding to an outer side of the upper thigh of the human body, and a second gas chamber of second group is positioned at a position corresponding to an inner side of the upper thigh of the human body.

The gas-type massage device can have a shape following at least a part of arms of the human body, and the gas-type massage device can be configured such that, when the gas-type massage device is fitted to the arms of the human body, a first gas chamber of first group is positioned at a position corresponding to an anterior side of the forearm of the human body, a second gas chamber of first group is positioned at a position corresponding to a posterior side of the forearm of the human body, a first gas chamber of second group is positioned at a position corresponding to an anterior side of the upper arm of the human body, and a second gas chamber of second group is positioned at a position corresponding to a posterior side of the upper arm of the human body.

The first gas chamber group can further have a third gas chamber of first group between a first gas chamber of first group and a second gas chamber of first group along the peripheral direction, the second gas chamber group can further have a third gas chamber of second group between a first gas chamber of second group and a second gas chamber of second group along the peripheral direction, and the third gas chamber of first group and the third gas chamber of second group can be provided so as to be mutually adjacent in the axial direction.

The gas-type massage device can have a shape following at least a part of legs of the human body, and, when the gas-type massage device is fitted to the legs of the human body, the first gas chamber of first group can be positioned at a position corresponding to an outer side of the lower thigh of the human body, the second gas chamber of first group can be positioned at a position corresponding to an inner side of the lower thigh of the human body, the third gas chamber of first group can be positioned at a position corresponding to a backside of the lower thigh of the human body, the first gas chamber of second group can be positioned at a position corresponding to an outer side of the upper thigh of the human body, the second gas chamber of second group can be positioned at a position corresponding to an inner side of the upper thigh of the human body, and the third gas chamber of second group can be positioned at a position corresponding to a backside of the upper thigh of the human body.

A gas-type massage apparatus according to one embodiment of the invention can be a gas-type massage apparatus to administer a massage to a human body using a high-pressure gas, wherein the gas-type massage apparatus comprises: the above-described gas-type massage device; and a gas supply/discharge system to supply a high-pressure gas to the plurality of gas chambers of the gas-type massage device and discharge a high-pressure gas from the plurality of gas chambers, and wherein the gas supply/discharge system is configured to supply a high-pressure gas to the first gas chamber group and then supply a high-pressure gas to the second gas chamber group.

A gas-type massage apparatus according to one embodiment of the invention can be a gas-type massage apparatus to administer a massage to a human body using a high-pressure gas, wherein the gas-type massage apparatus comprises: the gas-type massage device according to any embodiment disclosed herein; and a gas supply/discharge system to supply a high-pressure gas to the plurality of gas chambers of the gas-type massage device and discharge a high-pressure gas from the plurality of gas chambers, and wherein the gas supply/discharge system is configured to supply a high-pressure gas to a first gas chamber of first group, a second gas chamber of first group, a first gas chamber of second group, a second gas chamber of second group in that order, or to a second gas chamber of first group, a first gas chamber of first group, a second gas chamber of second group, a first gas chamber of second group in that order.

A gas-type massage apparatus according to one embodiment of the invention can be a gas-type massage apparatus to administer a massage to a human body using a high-pressure gas, wherein the gas-type massage apparatus comprises: the above-described gas-type massage device; and a gas supply/discharge system to supply a high-pressure gas to the plurality of gas chambers of the gas-type massage device and discharge a high-pressure gas from the plurality of gas chambers, and wherein the gas supply/discharge system is configured to supply a high-pressure gas to the third gas chamber of first group, the first gas chamber of first group, the second gas chamber of first group, the third gas chamber of second group, the first gas chamber of second group, the second gas chamber of second group in that order, or to the third gas chamber of first group, the second gas chamber of first group, the first gas chamber of first group, the third gas chamber of second group, the second gas chamber of second group, the first gas chamber of second group in that order.

### REFERENCE SIGNS LIST

1, 10 Gas-type massage apparatus

2, 4 Gas-type massage device

21 (A1 to G1,A2 to G2), 41 (A3 to F3) First gas chamber group

211 (D1, E1, D2, E2), 411 (C3, D3) First gas chamber of first group

2111 (D1, D2), 4111 (C3) First distal gas chamber of first group

2112 (E1, E2), 4112 (D3) First proximal gas chamber of first group

212 (F1, G1, F2, G2), 412 (E3, F3) Second gas chamber of first group

2121 (F1, F2), 4121 (E3) Second distal gas chamber of first group

2122 (G1, G2), 4122 (F3) Second proximal gas chamber of first group

213 (B1, C1, B2, C2) Third gas chamber of first group

2131 (B1, B2) Third distal gas chamber of first group

2132 (C1, C2) Third proximal gas chamber of first group

214 (A1, A2), 413 (A3, B3) End gas chamber of first group

21a First cover

21b Second cover

22 (H1 to L1, H2 to L2), 42 (G3 to J3) Second gas chamber group

221 (IL J1, I2, J2), 421 (G3, H3) First gas chamber of second group

2211 (IL I2), 4211 (G3) First distal gas chamber of second group

2212 (J1, J2), 4212 (H3) First proximal gas chamber of second group

222 (K1, L1, K2, L2), 422 (I3, J3) Second gas chamber of second group

2221 (K1, K2), 4221 (I3) Second distal gas chamber of second group

2222 (L1, L2), 4222 (J3) Second proximal gas chamber of second group

223 (H1, H2) Third gas chamber of second group

22a First fastening device

22b Second fastening device

23 (M to P), 43 (K3, L3) Third gas chamber group

231 (M) First gas chamber of third group

232 (N, P) Second gas chamber of third group

2321 (N) Second right gas chamber of third group

2322 (P) Second left gas chamber of third group

233 (O, O) Third gas chamber of third group

2331 (O) Third right gas chamber of third group

2332 (O) Third left gas chamber of third group

2a First gas-type massage device

2b Second gas-type massage device

2h, 20h Hose

3 Gas supply/discharge system

31 Gas supply apparatus

32 Flow path switching apparatus

33 Control apparatus

34 Operation part

3a Connector

4131 (A3) End distal gas chamber of first group

4132 (B3) End proximal gas chamber of first group

431 (K3) Distal gas chamber of third group

432 (L3) Proximal gas chamber of third group

4a Cover

Q1 Axial direction

Q2 Peripheral direction

Q3 Radial directions

Z Human body

Z1 to Z4 Lymph vessel group

1. A gas-type massage device to be fitted to at least one part of upper limbs or lower limbs of a human body along an axial direction in which the one part extends so as to surround the one part in a peripheral direction to administer a massage to the human body using a high-pressure gas,
wherein the gas-type massage device has a plurality of gas chambers, each of which plurality of gas chambers can receive and discharge a high-pressure gas to expand and contract mutually independently,
the plurality of gas chambers comprise a first gas chamber group and a second gas chamber group being provided so as to be mutually adjacent in the axial direction, and
each of the first gas chamber group and the second gas chamber group has the at least two gas chambers along the peripheral direction.

2. The gas-type massage device according to claim 1, wherein the first gas chamber group has a first gas chamber of first group and a second gas chamber of first group along the peripheral direction,
the second gas chamber group has a first gas chamber of second group and a second gas chamber of second group along the peripheral direction,
the first gas chamber of first group and the first gas chamber of second group are provided so as to be mutually adjacent in the axial direction, and
the second gas chamber of first group and the second gas chamber of second group are provided so as to be mutually adjacent in the axial direction.

3. The gas-type massage device according to claim 2, wherein the gas-type massage device has a shape following at least a part of legs of the human body, and,
the gas-type massage device is configured such that, when the gas-type massage device is fitted to the legs of the human body,
a first gas chamber of first group is positioned at a position corresponding to an outer side of the lower thigh of the human body,
a second gas chamber of first group is positioned at a position corresponding to an inner side of the lower thigh of the human body,
a first gas chamber of second group is positioned at a position corresponding to an outer side of the upper thigh of the human body, and
a second gas chamber of second group is positioned at a position corresponding to an inner side of the upper thigh of the human body.

4. The gas-type massage device according to claim 2, wherein the gas-type massage device has a shape following at least a part of arms of the human body, and
the gas-type massage device is configured such that, when the gas-type massage device is fitted to the arms of the human body,
a first gas chamber of first group is positioned at a position corresponding to an anterior side of the forearm of the human body,
a second gas chamber of first group is positioned at a position corresponding to a posterior side of the forearm of the human body,
a first gas chamber of second group is positioned at a position corresponding to an anterior side of the upper arm of the human body, and
a second gas chamber of second group is positioned at a position corresponding to a posterior side of the upper arm of the human body.

5. The gas-type massage device according to claim 2, wherein the first gas chamber group further has a third gas chamber of first group between a first gas chamber of first group and a second gas chamber of first group along the peripheral direction,
the second gas chamber group further has a third gas chamber of second group between a first gas chamber of second group and a second gas chamber of second group along the peripheral direction, and
the third gas chamber of first group and the third gas chamber of second group are provided so as to be mutually adjacent in the axial direction.

6. The gas-type massage device according to claim 5, wherein the gas-type massage device has a shape following at least a part of legs of the human body, and,
the gas-type massage device is configured such that, when the gas-type massage device is fitted to the legs of the human body,
the first gas chamber of first group is positioned at a position corresponding to an outer side of the lower thigh of the human body,
the second gas chamber of first group is positioned at a position corresponding to an inner side of the lower thigh of the human body,
the third gas chamber of first group is positioned at a position corresponding to a backside of the lower thigh of the human body,
the first gas chamber of second group is positioned at a position corresponding to an outer side of the upper thigh of the human body,
the second gas chamber of second group is positioned at a position corresponding to an inner side of the upper thigh of the human body, and
the third gas chamber of second group is positioned at a position corresponding to a backside of the upper thigh of the human body.

7. A gas-type massage apparatus to administer a massage to a human body using a high-pressure gas,
wherein the gas-type massage apparatus comprises:
the gas-type massage device according to claim 1; and
a gas supply/discharge system to supply a high-pressure gas to the plurality of gas chambers of the gas-type massage device and discharge a high-pressure gas from the plurality of gas chambers, and
wherein the gas supply/discharge system is configured to supply a high-pressure gas to the first gas chamber group and then supply a high-pressure gas to the second gas chamber group.

8. A gas-type massage apparatus to administer a massage to a human body using a high-pressure gas,
wherein the gas-type massage apparatus comprises:
the gas-type massage device according to claim 2; and
a gas supply/discharge system to supply a high-pressure gas to the plurality of gas chambers of the gas-type massage device and discharge a high-pressure gas from the plurality of gas chambers, and
wherein the gas supply/discharge system is configured to supply a high-pressure gas to the first gas chamber group and then supply a high-pressure gas to the second gas chamber group.

9. A gas-type massage apparatus to administer a massage to a human body using a high-pressure gas,
wherein the gas-type massage apparatus comprises:
the gas-type massage device according to claim 3; and
a gas supply/discharge system to supply a high-pressure gas to the plurality of gas chambers of the gas-type massage device and discharge a high-pressure gas from the plurality of gas chambers, and
wherein the gas supply/discharge system is configured to supply a high-pressure gas to the first gas chamber group and then supply a high-pressure gas to the second gas chamber group.

10. A gas-type massage apparatus to administer a massage to a human body using a high-pressure gas,
wherein the gas-type massage apparatus comprises:
the gas-type massage device according to claim 4; and
a gas supply/discharge system to supply a high-pressure gas to the plurality of gas chambers of the gas-type massage device and discharge a high-pressure gas from the plurality of gas chambers, and
wherein the gas supply/discharge system is configured to supply a high-pressure gas to the first gas chamber group and then supply a high-pressure gas to the second gas chamber group.

11. A gas-type massage apparatus to administer a massage to a human body using a high-pressure gas,
wherein the gas-type massage apparatus comprises:
the gas-type massage device according to claim 5; and
a gas supply/discharge system to supply a high-pressure gas to the plurality of gas chambers of the gas-type massage device and discharge a high-pressure gas from the plurality of gas chambers, and
wherein the gas supply/discharge system is configured to supply a high-pressure gas to the first gas chamber group and then supply a high-pressure gas to the second gas chamber group.

12. A gas-type massage apparatus to administer a massage to a human body using a high-pressure gas, wherein the gas-type massage apparatus comprises:
the gas-type massage device according to claim 6; and
a gas supply/discharge system to supply a high-pressure gas to the plurality of gas chambers of the gas-type massage device and discharge a high-pressure gas from the plurality of gas chambers, and
wherein the gas supply/discharge system is configured to supply a high-pressure gas to the first gas chamber group and then supply a high-pressure gas to the second gas chamber group.

13. A gas-type massage apparatus to administer a massage to a human body using a high-pressure gas, wherein the gas-type massage apparatus comprises:
the gas-type massage device according to claim 2; and
a gas supply/discharge system to supply a high-pressure gas to the plurality of gas chambers of the gas-type massage device and discharge a high-pressure gas from the plurality of gas chambers, and
wherein the gas supply/discharge system is configured to supply a high-pressure gas to a first gas chamber of first group, a second gas chamber of first group, a first gas chamber of second group, a second gas chamber of second group in that order, or to a second gas chamber of first group, a first gas chamber of first group, a second gas chamber of second group, a first gas chamber of second group in that order.

14. A gas-type massage apparatus to administer a massage to a human body using a high-pressure gas,
wherein the gas-type massage apparatus comprises:
the gas-type massage device according to claim 3; and
a gas supply/discharge system to supply a high-pressure gas to the plurality of gas chambers of the gas-type massage device and discharge a high-pressure gas from the plurality of gas chambers, and
wherein the gas supply/discharge system is configured to supply a high-pressure gas to a first gas chamber of first group, a second gas chamber of first group, a first gas chamber of second group, a second gas chamber of second group in that order, or to a second gas chamber of first group, a first gas chamber of first group, a second gas chamber of second group, a first gas chamber of second group in that order.

15. A gas-type massage apparatus to administer a massage to a human body using a high-pressure gas,
wherein the gas-type massage apparatus comprises:
the gas-type massage device according to claim 4; and
a gas supply/discharge system to supply a high-pressure gas to the plurality of gas chambers of the gas-type massage device and discharge a high-pressure gas from the plurality of gas chambers, and
wherein the gas supply/discharge system is configured to supply a high-pressure gas to a first gas chamber of first group, a second gas chamber of first group, a first gas chamber of second group, a second gas chamber of second group in that order, or to a second gas chamber of first group, a first gas chamber of first group, a second gas chamber of second group, a first gas chamber of second group in that order.

16. A gas-type massage apparatus to administer a massage to a human body using a high-pressure gas, wherein the gas-type massage apparatus comprises:
the gas-type massage device according to claim 5; and
a gas supply/discharge system to supply a high-pressure gas to the plurality of gas chambers of the gas-type massage device and discharge a high-pressure gas from the plurality of gas chambers, and
wherein the gas supply/discharge system is configured to supply a high-pressure gas to the third gas chamber of first group, the first gas chamber of first group, the second gas chamber of first group, the third gas chamber of second group, the first gas chamber of second group, the second gas chamber of second group in that order, or to the third gas chamber of first group, the second gas chamber of first group, the first gas chamber of first group, the third gas chamber of second group, the second gas chamber of second group, the first gas chamber of second group in that order.

17. A gas-type massage apparatus to administer a massage to a human body using a high-pressure gas, wherein the gas-type massage apparatus comprises:
the gas-type massage device according to claim 6; and
a gas supply/discharge system to supply a high-pressure gas to the plurality of gas chambers of the gas-type massage device and discharge a high-pressure gas from the plurality of gas chambers, and
wherein the gas supply/discharge system is configured to supply a high-pressure gas to the third gas chamber of first group, the first gas chamber of first group, the second gas chamber of first group, the third gas chamber of second group, the first gas chamber of second group, the second gas chamber of second group in that order, or to the third gas chamber of first group, the second gas chamber of first group, the first gas chamber of first group, the third gas chamber of second group, the second gas chamber of second group, the first gas chamber of second group in that order.
